(19) United States
(12) Patent Application Publication
(10) Pub. No.: US 2026/0186647 A1
(43) Pub. Date: Jul. 2, 2026

(54) METHODS, APPARATUSES, AND NON-TRANSITORY COMPUTER-READABLE STORAGE MEDIA FOR TOUCH INPUT WITH RESTING DETECTION

(71) Applicant: HUAWEI TECHNOLOGIES CO., LTD., Shenzhen (CN)

(72) Inventors: Shuping Lu, Richmond HIll (CA); Wei Li, Markham (CA); Soheil Kianzad, Markham (CA); Che Yan, Markham (CA); Yuan Deng, Markham (CA); Jiaming Shi, Shanghai (CN); Zhen Li, Toronto (CA)

(21) Appl. No.: 19/006,656

(22) Filed: Dec. 31, 2024

(51) Int. Cl. G06F 3/04886; G06F 3/041; G06F 3/044

(52) U.S. Cl. CPC G06F 3/04886; G06F 3/04166; G06F 3/04186; G06F 3/0445; G06F 2203/04104; G06F 2203/04803

(57) ABSTRACT

A computerized method has the steps of: obtaining one or more first touches on a touch surface; and determining that the one or more first touches are resting on the touch surface if any of following first conditions is true: each first touch being contacting the touch surface without movement for longer than a first time duration, the one or more first touches being a plurality of first touches sequentially contacting the touch surface, the one or more first touches being a plurality of first touches contacting the touch surface substantially at a same time and remaining in contact with the touch surface for longer than a second time duration, the one or more first touches being in contact with the touch surface at one or more locations outside an input area or at one or more locations inside an resting area, or a combination thereof.

### FIELD OF THE DISCLOSURE

The present disclosure relates generally to computing apparatuses, and methods and non-transitory computer-readable storage media therefor, and in particular to computing apparatuses using capacitive touch, and methods and non-transitory computer-readable storage media therefor.

### BACKGROUND

Touch-based input technologies have gain increased popularity in various applications such as devices with touchscreens (for example, desktop and laptop computers with touchscreens, smartphones, tablets, foldable smartphones, and/or the like), due to their ability to offer a portable and flexible user experience. For example, foldable smartphones (and some laptops) comprise dual screens to maximize workspace by allowing users to operate without a physical keyboard. In these portable devices, a virtual keyboard becomes essential for productivity, as these devices are often equipped without any physical keyboards.

To address this, operating systems such as MICROSOFT® WINDOWS® (MICROSOFT and WINDOWS are registered trademarks of the Microsoft Corp., Redmond, WA, USA) has integrated virtual keyboards to support text input in the absence of physical keyboards. While these virtual keyboards serve as a viable replacement, they come with several limitations compared to their physical counterparts, which impacts user experience, typing efficiency, and accuracy.

One of the key drawbacks when typing on a virtual keyboard is unintentional touch errors that may often occur due to lack of physicality of the key and/or lack of tactile feedback. Physical keyboards provide key caps, edges, and other physical cues that help guide the fingers. Virtual keyboards, on the other hand, do not offer such physical boundaries, which leads to increased unintentional touch errors, reducing typing accuracy and overall user satisfaction.

Many virtual keyboards in prior art only detect two states: “touched” and “untouched”, thereby forcing users to maintain their fingers in a hovering position while typing. This creates significant fatigue during extended typing sessions. Unlike physical keyboards, which allow users to rest their fingers between key presses, many virtual keyboards have no mechanism to differentiate between resting and typing actions, further exacerbating the issue.

A well-designed virtual keyboard that can accurately simulate the feel and responsiveness of a physical keyboard will enhance productivity and comfort for users of touch-enabled computing devices such as foldable personal computers (PCs), foldable smartphones, foldable tablets, and other devices with touchscreens and/or touchpads. Thus, there is a desire for advanced virtual keyboard technologies to enable a seamless user experience.

### SUMMARY

According to one aspect of this disclosure, there is provided a computerized method comprising: obtaining one or more first touches on a touch surface; and determining that the one or more first touches are resting on the touch surface if any of following first conditions is true: each of the one or more first touches being contacting the touch surface without movement for longer than a first time duration, the one or more first touches being a plurality of first touches sequentially contacting the touch surface, the one or more first touches being a plurality of first touches contacting the touch surface substantially at a same time and remaining in contact with the touch surface for longer than a second time duration, the one or more first touches being in contact with the touch surface at one or more locations outside an input area or at one or more locations inside an resting area, or a combination thereof.

In some embodiments, the first time duration is 250 milliseconds (ms) or 500 ms.

In some embodiments, said the one or more first touches being the plurality of first touches sequentially contacting the touch surface comprises: the one or more first touches being more than three first touches sequentially contacting the touch surface.

In some embodiments, said the one or more first touches being the plurality of first touches sequentially contacting the touch surface comprises: the one or more first touches being the plurality of first touches, and a counting of touches applied to the touch surface being increasing during a first time period that the plurality of first touches contacting the touch surface.

In some embodiments, said the one or more first touches are the plurality of first touches sequentially contacting the touch surface comprises: the one or more first touches are the plurality of first touches belonging to a same hand and sequentially contacting the touch surface.

In some embodiments, said the one or more first touches being the plurality of first touches contacting the touch surface substantially at the same time and remaining in contact with the touch surface for longer than the second time duration comprises: the one or more first touches being at least two first touches contacting the touch surface within a second time period and remaining in contact with the touch surface for longer than the second time duration.

In some embodiments, the second time period is 30 ms.

In some embodiments, the method further comprises: obtaining one or more second touches on the touch surface; obtaining a touch-force estimate for each of the one or more second touches; and determining that the one or more second touches are accidental touches if any of following second conditions is true: the one or more second touches being a plurality of second touches contacting the touch surface substantially at a same time and the touch-force of each of the one or more second touches being less than a first force threshold, the one or more second touches being a single second touch and the touch-force thereof being less than a second force threshold, or a combination thereof.

In some embodiments, said the one or more second touches being the plurality of second touches contacting the touch surface substantially at the same time and the touch-force of each of the one or more second touches being less than the first force threshold comprises: the one or more second touches being the plurality of second touches contacting the touch surface substantially at the same time, the touch-force of each of the one or more second touches being less than the first force threshold, and the one or more second touches being maintained on the touch surface for less than a third time duration.

In some embodiments, said the one or more second touches being the plurality of second touches contacting the touch surface substantially at the same time and the touch-force of each of the one or more second touches being less than the first force threshold comprises: the one or more second touches being the plurality of second touches belonging to a same hand and contacting the touch surface substantially at the same time, the touch-force of each of the one or more second touches being less than the first force threshold, and the one or more second touches being maintained on the touch surface for less than a third time duration.

In some embodiments, the third time duration is 30 ms.

In some embodiments, said the one or more second touches being the single second touch and the touch-force thereof being less than the second force threshold comprises: the one or more second touches being the single second touch and the touch-force thereof being less than the second force threshold and being maintained on the touch surface for less than a fourth time duration.

In some embodiments, the fourth time duration is 30 ms.

In some embodiments, the method further comprises: obtaining a plurality third touches on the touch surface; and initializing a virtual keyboard on the touch surface.

In some embodiments, the plurality of third touches are ten, nine, eight, seven, or six touches.

In some embodiments, said initializing the virtual keyboard on the touch surface comprises: initializing and positioning the virtual keyboard on the touch surface such that a plurality of keys of the virtual keyboard are positioned in accordance with positions of the plurality of third touches.

In some embodiments, the method further comprises: determining a movement of the plurality of third touches; and moving the virtual keyboard with the movement of the plurality of third touches.

In some embodiments, said moving the virtual keyboard with the movement of the plurality of third touches comprises: moving the virtual keyboard with the movement of the plurality of third touches if the movement of the plurality of third touches is substantially along a predefined direction with respect to the touch surface.

In some embodiments, said moving the virtual keyboard with the movement of the plurality of third touches comprises: moving the virtual keyboard with the movement of the plurality of third touches if the movement of the plurality of third touches is with 30° around a predefined direction with respect to the touch surface.

In some embodiments, the method further comprises: obtaining a plurality of fourth touches substantially contacting a same position on the touch surface within a fifth time duration; and generating one touch event for the plurality of fourth touches.

According to one aspect of this disclosure, there is provided an apparatus comprising: one or more processors; and one or more non-transitory, computer-readable storage media comprising computer-executable instructions; wherein the instructions, when executed, cause one or more processors to perform any of the above-described methods and/or any of the methods disclosed herein.

According to one aspect of this disclosure, there is provided an apparatus comprising one or more processors functionally connected to one or more memories storing instructions; the one or more processors are configured to execute the instructions to perform any of the above-described methods and/or any of the methods disclosed herein.

According to one aspect of this disclosure, there is provided one or more memories storing instructions; the instructions, when executed, cause one or more processors to perform any of the above-described methods and/or any of the methods disclosed herein.

In another aspect, embodiments of this disclosure provide an apparatus, wherein the apparatus comprises a function or unit to perform any of the above-described methods and/or any of the methods disclosed herein.

In another aspect, embodiments of this disclosure provide a computer readable storage medium, comprising one or more instructions, wherein when the one or more instructions are run on a computer, the computer performs any of the above-described methods and/or any of the methods disclosed herein.

In another aspect, embodiments of this disclosure provide a non-transitory computer-readable medium storing instruction the instructions causing a processor in a device to implement any of the above-described methods and/or any of the methods disclosed herein.

In another aspect, embodiments of this disclosure provide a device configured to perform any of the above-described methods and/or any of the methods disclosed herein.

In another aspect, embodiments of this disclosure provide a processor, configured to execute instructions to cause a device to perform any of the above-described methods and/or any of the methods disclosed herein.

In another aspect, embodiments of this disclosure provide an integrated circuit configure to perform any of the above-described methods and/or any of the methods disclosed herein.

According to one aspect of this disclosure, there is provided a module comprising: one or more circuits for performing any of the above-described methods and/or any of the methods disclosed herein.

According to one aspect of this disclosure, there is provided one or more processors functionally connected to one or more memories for performing any of the above-described methods and/or any of the methods disclosed herein.

According to one aspect of this disclosure, there is provided an apparatus comprising: one or more processors functionally connected to one or more memories for performing any of the above-described methods and/or any of the methods disclosed herein.

According to one aspect of this disclosure, there is provided an apparatus configured to perform any of the above-described methods and/or any of the methods disclosed herein.

In some embodiments the apparatus comprises one or more units configured to perform any of the above-described methods and/or any of the methods disclosed herein.

According to one aspect of this disclosure, there is provided one or more non-transitory, computer-readable storage media comprising computer-executable instructions, wherein the instructions, when executed, cause at least one processing unit, at least one processor, or at least one circuits to perform any of the above-described methods and/or any of the methods disclosed herein.

According to one aspect of this disclosure, there is provided one or more computer-readable storage media storing a computer program, wherein, when the computer program is executed by an apparatus, the apparatus is enabled to implement any of the above-described methods and/or any of the methods disclosed herein.

According to one aspect of this disclosure, there is provided a computer program product including one or more instructions, wherein, when the instructions are executed by an apparatus, the apparatus is enabled to implement any of the above-described methods and/or any of the methods disclosed herein.

According to one aspect of this disclosure, there is provided a computer program, wherein, when the computer program is executed by a computer, an apparatus is enabled to implement any of the above-described methods and/or any of the methods disclosed herein.

According to one aspect of this disclosure, there is provided a system comprising a node for performing any of the above-described methods and/or any of the methods disclosed herein.

According to one aspect of this disclosure, there is provided an apparatus for implementing any of the above-described methods and/or any of the methods disclosed herein in any possible implementation of the foregoing aspects.

In various embodiments, the computing device and methods disclosed herein provide various technical benefits.

For example, the computing device and methods disclosed herein provide reduction of typing fatigue. By enabling both multi-finger resting and palm resting modes, the computing device and methods disclosed herein significantly reduce typing fatigue. This improvement allows users to rest their hands while typing, replicating the comfort and ergonomics of physical keyboards.

The computing device and methods disclosed herein provide enhanced user experience. The virtual keyboard's performance may reach, for example, approximately 80% of a physical keyboard's speed and accuracy, providing a highly competitive and effective alternative for users accustomed to traditional keyboards.

The computing device and methods disclosed herein provide multi-finger and blind typing support. The computing device and methods disclosed herein provide enable users to type efficiently with multiple fingers and even supports blind typing, a feature that many prior-art technologies have struggled to implement effectively. This is especially beneficial for users with a background in touch typing, enhancing productivity.

The computing device and methods disclosed herein provide replacement of physical keyboards in foldable PCs. The computing device and methods disclosed herein provide an opportunity for virtual keyboards to replace physical ones in foldable PC designs, helping to streamline and optimize the design and functionality of these devices.

The computing device and methods disclosed herein provide practical integration with capacitive sensors. The virtual keyboard leverages existing capacitive sensor data without requiring additional hardware or sensors, making it a cost-effective and practical solution for manufacturers and designers of touchscreen devices.

The computing device and methods disclosed herein provide accidental touch filtering. One of the benefits is the reduction of accidental touches during multi-finger typing. The carefully designed filtering mechanisms of the computing device and methods disclosed herein ensure that accidental touches are minimized to, for example, less than 10%, demonstrating a significant improvement over prior-art virtual keyboard technologies.

### BRIEF DESCRIPTION OF THE DRAWINGS

For a more complete understanding of the disclosure, reference is made to the following description and accompanying drawings, in which:

FIG. 1 is a schematic diagram showing a simplified hardware structure of a computing device;

FIG. 2 is a schematic diagram showing a simplified software architecture of the computing device shown in FIG. 1;

FIG. 3 is a schematic diagram showing the functional structure of the computing device shown in FIG. 1 for implementing a virtual keyboard, according to some embodiments of this disclosure;

FIG. 4 is a schematic diagram showing the touch-point processing pipeline of the virtual keyboard for converting raw touch data from a touch panel into valid keypress events while mitigating the effects of unintended touches, according to some embodiments of this disclosure;

FIG. 5 shows three types of touch states used by the virtual keyboard, according to some embodiments of this disclosure;

FIG. 6 is a state transition diagram of a state machine for keyboard multi-finger rest and typing, according to some embodiments of this disclosure;

FIG. 7 is a flowchart showing the steps of an anchoring detection procedure executed by the virtual keyboard, according to some embodiments of this disclosure;

FIGS. 8A and 8B show a flowchart illustrating the resting detection method, according to some embodiments of this disclosure;

FIGS. 9A to 9C show a capacitive touch surface that is used for estimating a touch force, according to some embodiments of this disclosure;

FIG. 10 shows a hand geometry model, according to some embodiments of this disclosure;

FIG. 11 is a flowchart showing a procedure of filtering accidental touches for filtering coactivation touch and light touch, according to some embodiments of this disclosure;

FIG. 12A shows an example of keyboard typing with palm resting supported by anchoring state's keyboard height adjustment, according to some embodiments of this disclosure;

FIG. 12B is a state transition diagram of the example shown in FIG. 12A, according to some embodiments of this disclosure;

FIG. 13A is a flowchart showing an example of a procedure of resting detection with finger touch at the same time, according to some embodiments of this disclosure;

FIG. 13B is a state transition diagram of the example shown in FIG. 13A, according to some embodiments of this disclosure;

FIG. 14A is a flowchart showing an example of a procedure of resting detection with finger touch not at the same time, according to some embodiments of this disclosure;

FIG. 14B is a state transition diagram of the example shown in FIG. 14A, according to some embodiments of this disclosure;

FIG. 15 is a state transition diagram of an example of performing long key handling, according to some embodiments of this disclosure;

FIG. 16A is a flowchart showing an example of a procedure of resting with finger touch at the same time and then typing, according to some embodiments of this disclosure;

FIG. 16B is a state transition diagram of the example shown in FIG. 16A, according to some embodiments of this disclosure;

FIG. 17A is a flowchart showing an example of a procedure of handling the scenarios where fingers contact the touch surface at different times and then the user transitions from resting to typing, according to some embodiments of this disclosure;

FIG. 17B is a state transition diagram of the example shown in FIG. 17A, according to some embodiments of this disclosure;

FIG. 18 is a state transition diagram of an example of handles typing with palm on the touch surface, according to some embodiments of this disclosure; and

FIGS. 19A and 19B show an example of a user typing on a virtual keyboard displayed on a touchscreen of a laptop, according to some embodiments of this disclosure, wherein the virtual keyboard implements palm rejection.

### DETAILED DESCRIPTION

### A. System Structure

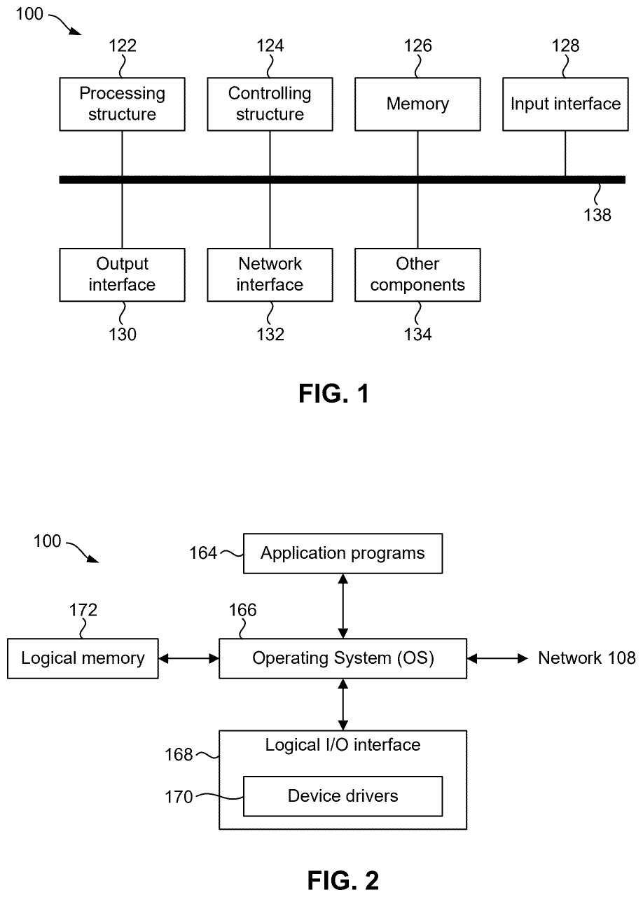

Turning now to FIG. 1, a computing device is shown and is generally identified using reference numeral 100. As shown, the computing device 100 comprises a processing structure 122, a controlling structure 124, one or more non-transitory computer-readable memory or storage devices or media 126, an input interface 128, and an output interface 130, functionally interconnected by a system bus 138. The computing device 100 may also comprise a network interface 132 and/or other components 134 coupled to the system bus 138.

The processing structure 122 may be one or more single-core or multiple-core computing processors, generally referred to as central processing units (CPUs), such as INTEL® microprocessors (INTEL is a registered trademark of Intel Corp., Santa Clara, CA, USA), AMD® microprocessors (AMD is a registered trademark of Advanced Micro Devices Inc., Sunnyvale, CA, USA), ARM® microprocessors (ARM is a registered trademark of Arm Ltd., Cambridge, UK) manufactured by a variety of manufactures such as Qualcomm of San Diego, California, USA, under the ARM® architecture, NVIDIA processor, or the like. When the processing structure 122 comprises a plurality of processors, the processors thereof may collaborate via a specialized circuit such as a specialized bus or via the system bus 138.

The processing structure 122 may also or alternatively comprise one or more real-time processors, programmable logic controllers (PLCs), microcontroller units (MCUs), μ-controllers (UCs), specialized/customized processors, hardware accelerators, and/or controlling circuits (also denoted “controllers”) using, for example, field-programmable gate array (FPGA) or application-specific integrated circuit (ASIC) technologies, and/or the like. In some embodiments, the processing structure includes a CPU (otherwise referred to as a host processor) and a specialized hardware accelerator which includes circuitry configured to perform computations of neural networks such as tensor multiplication, matrix multiplication, and the like. The host processor may offload some computations to the hardware accelerator to perform computation operations of neural network. Examples of a hardware accelerator include a graphics processing unit (GPU), Neural Processing Unit (NPU), and Tensor Process Unit (TPU). In some embodiments, the host processors and the hardware accelerators (such as the GPUs, NPUs, and/or TPUs) may be generally considered processors.

Generally, the processing structure 122 comprises necessary circuitries implemented using technologies such as electrical and/or optical hardware components for executing one or more processes, as the design purpose and/or the use case maybe. For example, the processing structure 122 may comprise logic gates implemented by semiconductors to perform various computations, calculations, and/or processings. Examples of logic gates include AND gate, OR gate, XOR (exclusive OR) gate, and NOT gate, each of which takes one or more inputs and generates or otherwise produces an output therefrom based on the logic implemented therein. For example, a NOT gate receives an input (for example, a high voltage, a state with electrical current, a state with an emitted light, or the like), inverts the input (for example, forming a low voltage, a state with no electrical current, a state with no light, or the like), and output the inverted input as the output.

While the inputs and outputs of the logic gates are generally physical signals and the logics or processing thereof are tangible operations with physical results (for example, outputs of physical signals), the inputs and outputs thereof are generally described using numerals (for example, numerals “0” and “1”) and the operations thereof are generally described as “computing” (which is how the “computer” or “computing device” is named) or “calculation”, or more generally, “processing”, for generating or producing the outputs from the inputs thereof.

Sophisticated combinations of logic gates in the form of a circuitry of logic gates, such as the processing structure 122, may be formed using a plurality of AND, OR, XOR, and/or NOT gates. Such combinations of logic gates may be implemented using individual semiconductors, or more often be implemented as integrated circuits (ICs).

A circuitry of logic gates may be “hard-wired” circuitry which, once designed, may only perform the designed functions. In this example, the processes and functions thereof are “hard-coded” in the circuitry.

With the advance of technologies, it is often that a circuitry of logic gates such as the processing structure 122 may be alternatively designed in a general manner so that it may perform various processes and functions according to a set of “programmed” instructions implemented as firmware and/or software and stored in one or more non-transitory computer-readable storage devices or media. In this example, the circuitry of logic gates such as the processing structure 122 is usually of no use without meaningful firmware and/or software.

Of course, those skilled the art will appreciate that a process or a function (and thus the processor 122) may be implemented using other technologies such as analog technologies.

Referring back to FIG. 1, the controlling structure 124 comprises one or more controlling circuits, such as graphic controllers, input/output chipsets and the like, for coordinating operations of various hardware components and modules of the computing device 100.

The memory 126 comprises one or more storage devices or media accessible by the processing structure 122 and the controlling structure 124 for reading and/or storing instructions for the processing structure 122 to execute, and for reading and/or storing data, including input data and data generated by the processing structure 122 and the controlling structure 124. The memory 126 may be volatile and/or non-volatile, non-removable or removable memory such as RAM, ROM, EEPROM, solid-state memory, hard disks, CD, DVD, flash memory, or the like.

The input interface 128 comprises one or more input modules for one or more users to input data via, for example, touch-sensitive screen (also called “touchscreen”), touch-sensitive whiteboard, touchpad, keyboards, computer mouse, trackball, microphone, scanners, cameras, and/or the like. The input interface 128 may be a physically integrated part of the computing device 100 (for example, the touchpad of a laptop computer or the touch-sensitive screen of a tablet), or may be a device physically separate from, but functionally coupled to, other components of the computing device 100 (for example, a computer mouse). The input interface 128, in some implementation, may be integrated with a display output to form a touch-sensitive screen or touch-sensitive whiteboard.

The output interface 130 comprises one or more output modules for output data to a user. Examples of the output modules comprise displays (such as monitors, LCD displays, LED displays, projectors, and the like), speakers, printers, virtual reality (VR) headsets, augmented reality (AR) goggles, and/or the like. The output interface 130 may be a physically integrated part of the computing device 100 (for example, the display of a laptop computer or tablet), or may be a device physically separate from but functionally coupled to other components of the computing device 100 (for example, the monitor of a desktop computer).

The computing device 100 may also comprise a network interface 132, which comprises one or more network modules for connecting to other computing devices or networks by using suitable wired or wireless communication technologies such as Ethernet, WI-FI® (WI-FI is a registered trademark of Wi-Fi Alliance, Austin, TX, USA), BLUETOOTH® (BLUETOOTH is a registered trademark of Bluetooth Sig Inc., Kirkland, WA, USA), Bluetooth Low Energy (BLE), Z-Wave, Long Range (LoRa), ZIGBEE® (ZIGBEE is a registered trademark of ZigBee Alliance Corp., San Ramon, CA, USA), wireless broadband communication technologies such as Global System for Mobile Communications (GSM), Code Division Multiple Access (CDMA), Universal Mobile Telecommunications System (UMTS), Worldwide Interoperability for Microwave Access (WiMAX), CDMA2000, Long Term Evolution (LTE), 3GPP, fifth-generation New Radio (5G NR) and/or other 5G networks, fifth-generation (6G) networks, and/or the like. In some embodiments, parallel ports, serial ports, USB connections, optical connections, or the like may also be used for connecting other computing devices or networks although they are usually considered as input/output interfaces for connecting input/output devices.

The computing device 100 may also comprise other components 134 such as one or more positioning modules, temperature sensors, barometers, inertial measurement unit (IMU), and/or the like.

The system bus 138 interconnects various components 122 to 134 enabling them to transmit and receive data and control signals to and from each other.

FIG. 2 shows a simplified software architecture of the computing device 100. On the software side, the computing device 100 comprises one or more application programs 164, an operating system 166, a logical input/output (I/O) interface 168, and a logical memory 172. The one or more application programs 164, operating system 166, and logical I/O interface 168 are generally implemented as computer-executable instructions or code in the form of software programs or firmware programs stored in the logical memory 172 which may be executed by the processing structure 122.

The one or more application programs 164 executed by or run by the processing structure 122 for performing various tasks.

The operating system 166 manages various hardware components of the computing device 100 via the logical I/O interface 168, manages the logical memory 172, and manages and supports the application programs 164. The operating system 166 is also in communication with other computing devices (not shown) via a network 108 to allow application programs 164 to communicate with those running on other computing devices. As those skilled in the art will appreciate, the operating system 166 may be any suitable operating system such as MICROSOFT® WINDOWS®, APPLE® OS X, APPLE® iOS (APPLE is a registered trademark of Apple Inc., Cupertino, CA, USA), Linux, ANDROID® (ANDROID is a registered trademark of Google LLC, Mountain View, CA, USA), or the like. The computing device 100 may all have the same operating system, or may have different operating systems.

The logical I/O interface 168 comprises one or more device drivers 170 for communicating with respective input and output interfaces 128 and 130 for receiving data therefrom and sending data thereto. Received data may be sent to the one or more application programs 164 for being processed by one or more application programs 164. Data generated by the application programs 164 may be sent to the logical I/O interface 168 for outputting to various output devices (via the output interface 130).

The logical memory 172 is a logical mapping of the physical memory 126 for facilitating the application programs 164 to access. In this embodiment, the logical memory 172 comprises a storage memory area that may be mapped to a non-volatile physical memory such as hard disks, solid-state disks, flash drives, and the like, generally for long-term data storage therein. The logical memory 172 also comprises a working memory area that is generally mapped to high-speed, and in some implementations volatile, physical memory such as RAM, generally for application programs 164 to temporarily store data during program execution. For example, an application program 164 may load data from the storage memory area into the working memory area, and may store data generated during its execution into the working memory area. The application program 164 may also store some data into the storage memory area as required or in response to a user's command.

The computing device 100 is generally a combination of its hardware and software. As those skilled in the art understand, the processing structure 122 is usually of no use without meaningful firmware and/or software. Similarly, while a computing device 100 may have the potential to perform various tasks, it cannot perform any tasks and is of no use without meaningful firmware and/or software. As will be described in more detail later, the computing device 100 described herein and the modules, circuits, and components thereof, as a combination of hardware and software, generally produces tangible results tied to the physical world, wherein the tangible results such as those described herein may lead to improvements to the computer devices and systems themselves, the modules, circuitries, and components thereof, and/or the like.

### B. Virtual Keyboard

Herein, the computing device 100 may be any suitable computing device comprising a touch-sensitive input component as part of the input interface 128, and implements a virtual keyboard for receiving user input. As those skilled in the art understand, a virtual keyboard is a software implemented keyboard that does not have any physical keys. Generally, a virtual keyboard may be implemented on the touch surface of a touchscreen, a touch pad, or any other suitable touch-sensitive input component (collectively denoted a “touch panel”), wherein an area thereof is defined as a virtual keyboard having a plurality of subareas each corresponding to a key. Examples of the computing device 100 that may implement a virtual keyboard include foldable computing device having one or more touchscreens (such as foldable personal computer (PC), foldable smartphone, foldable tablet, or the like), desktop computer with a touchscreen, computer with a projector for display and a touchpad for input, or the like. In various embodiments, the virtual keyboard may be displayed on the touchscreen, projected on the touchpad, painted or printed on the touchpad, and/or the like.

Various virtual keyboards have been used in prior art.

One type of virtual keyboards is the adaptive keyboard. For example, tablet soft keyboards offer a unique advantage over physical keyboards due to their flexibility and adaptability. Such soft keyboards may use dynamic keyboard layouts, wherein the keyboard layout may change based on input languages, typing postures, hand positions, and even the user's previous input sequences. In some soft keyboards, keys may be resized according to their usage frequency, making them easier for users to tap the most frequently used keys. Some soft keyboards use the traditional keyboard layout but dynamically highlight or enlarge keys that have higher probabilities of being the next input. These features enhance typing efficiency by reducing the effort required to locate keys.

In prior art, personalized touch models have been used to adjust the keyboard layout to suit individual typing patterns. Some virtual keyboards also incorporate real-time personalization of key size and positioning. These approaches helped minimize user fatigue and improved typing accuracy.

Research has also shown that how users hold a device affects touch models. Based on this insight, some virtual keyboards modify the touch model or keyboard layout based on the device's orientation or posture, though these solutions relied on additional posture-sensing technologies.

In some designs, the virtual keyboard is rearranged to match the position of the user's resting fingers. However, these systems may not fully resolve the issue of unintentional touches. Some virtual keyboards use a threshold method to filter out unintended inputs. Although effective, such systems often do not implement a fully adaptive keyboard, leaving room for further improvement.

Another type of virtual keyboards is the low-occlusion keyboard.

Traditional virtual keyboards can take up a large portion of the screen, reducing the available space for other tasks. To address this, some systems have minimized the keyboard's footprint by introducing chorded typing methods to reduce the number of visible keys. While this solution helped free up screen space, it came with a steep learning curve and decreased typing speeds.

Other approaches move the keyboard to the back of the device, allowing users to type with both hands while maintaining a clear view of the screen. However, this design altered the traditional QWERTY layout, which made the typing experience less intuitive for most users.

In prior art, invisible keyboards are also used on, for example, on smartphones and tablets, where the keys are not displayed on the screen, allowing users to type based on muscle memory. These designs achieve high accuracy while maintaining a familiar QWERTY layout. However, they still suffered from challenges in decoding accuracy when users couldn't locate keys precisely.

Another type of virtual keyboards for touchscreens and wearable technology use the statistical decoding algorithms such as the Bayesian decoder to improve text entry accuracy on virtual keyboards. These algorithms predict the most likely input words by analyzing the probability distributions of previous inputs and touchpoints.

For invisible keyboards, where users cannot precisely locate keys, relative touch models are used to estimate input. These algorithms greatly enhance typing accuracy on invisible keyboards but still faced limitations when adapting to different touch models and user behaviors.

The TapBoard research by Korea Advanced Institute of Science and Technology, Daejeon, Republic of Korea introduces a state machine to switch between tapping actions (such as typing) and resting for improving typing on virtual keyboards. The TapBoard considers a touch to be a keystroke, while longer contacts are interpreted as resting states. The first version (TapBoard 1) has significant limitations, including a 450 milliseconds (ms) timeout, which reduces typing speed and overall performance. Additionally, the system struggles to process multi-finger input effectively and had issues with combination keys and long presses, often misclassifying them as resting states.

TapBoard 2 seeks to improve upon these shortcomings by factoring in contact time and sequence to better handle mouse-like interactions on touchscreens. However, despite these improvements, TapBoard 2 still faces challenges with multi-finger typing. Long press functionality remains problematic, as long presses are frequently misinterpreted as resting states. These issues make TapBoard unsuitable for users who require high typing accuracy and speed in a virtual keyboard environment.

ResType Keyboard developed by Tsinghua University, China attempts to leverage finger resting in a more adaptive manner. By utilizing the Sensel Board (a force sensor equipped touch panel offered by Sensel, Inc. of Sunnyvale, CA, USA) to detect different typing forces, ResType allows users to blind-type by distinguishing between resting and typing actions based on the pressure exerted by the fingers. Lighter touches are recognized as resting, while heavier touches are registered as key presses. This reduces the fatigue caused by hovering fingers, as users can rest their fingers on the surface without triggering unintended keystrokes.

Despite these advancements, ResType still has notable limitations. The system relies on complex hardware such as the Sensel Board, which increases production costs and makes it less practical for mainstream devices. Moreover, ResType heavily depends on machine learning models to differentiate between resting and typing actions. With over 130 absolute model parameters and 3,380 relative parameters, the system is highly complex and can introduce latency issues. Additionally, the reliance on specific hardware makes it difficult to scale ResType for broader consumer applications.

Other virtual keyboards are also available.

For example, U.S. Pat. No. 8,605,051 B2 to Hotelling, et al. addresses the core functionality of multipoint touchscreens by detailing a touch panel with a transparent capacitive sensing medium capable of detecting multiple touches or near touches simultaneously at distinct locations, producing distinct signals for each touch.

U.S. Pat. No. 9,348,458 B2 to Hotelling, et al. covers methods and systems for processing touch inputs on a multipoint sensing device, laying the groundwork for efficient touch data processing and detection on these screens.

U.S. Pat. No. 10,338,789 B2 to Ording describes a virtual input device comprising multiple virtual keys on a touch screen, focusing on user-friendly virtual keyboard interfaces that interpret multipoint touches.

U.S. Pat. No. 7,653,883 B2 to Hotelling, et al. presents proximity-based systems for electronic devices, where actions are triggered based on the detected proximity of objects to the touch panel, enhancing the interaction capabilities of multipoint touch interfaces.

These patents demonstrate significant advancements in the field of capacitive touch sensing, multipoint input detection, and user interaction on touch-sensitive devices.

Despite the advancements in multipoint touchscreens and virtual keyboards, several disadvantages remain in the prior art:
Multi-finger input issues: many systems such as TapBoard may struggle with effectively handling multi-finger input. This results in misinterpretations of long presses or combination keys, which can hinder typing speed and accuracy.
Unintentional touch detection: solutions such as TapBoard use threshold methods to filter out unintentional touches. However, they often lack the sophistication to adapt dynamically to user behavior, leading to frequent misclassifications of resting states as active inputs.
Complex hardware requirements: innovations such as ResType require specialized hardware such as the Sensel Board to distinguish between typing and resting actions. These complex systems may increase production costs and limit the scalability of such technologies for mainstream consumer devices.
Latency and processing complexity: some systems such as ResType rely heavily on machine learning models with thousands of parameters, leading to potential latency issues and high computational demands. This complexity may make these solutions impractical for broader, cost-effective applications.
Learning curve and usability: low-occlusion keyboards and invisible typing solutions, while freeing up screen space, often introduce steep learning curves and can result in reduced typing speeds for new users, affecting their usability.

Herein, various embodiments of virtual keyboards are disclosed. The virtual keyboards disclosed herein addresses one or more key technical challenges in prior-art virtual keyboard systems, such as those for devices using multipoint touchscreens (such as tablets, foldable PCs, and other mobile or hybrid computing devices). The virtual keyboards disclosed herein solve at least some of the following challenges:
Accidental touch and resting finger input:

Virtual keyboards often suffer from accidental touch inputs when users rest their fingers on the screen while typing. Differentiating between actual typing actions and unintentional resting fingers is important to avoid inaccurate keypresses. The virtual keyboards need to prevent accidental touches from activating keys when the user interacts with the screen in non-typing scenarios (for example, using gestures to scroll).
Multi-finger input processing:

Multi-touch systems need to process multiple touchpoints simultaneously to ensure accurate detection of multi-finger typing without confusion between different touch actions. Detecting each finger individually, tracking their movements, and understanding their state (such as resting, moving, typing, and/or the like) is important for seamless multi-finger input processing.
Typing fatigue reduction:

Users often experience fatigue when using virtual keyboards because they must hover their fingers over the screen to avoid accidental touches. The virtual keyboards need to allow users to rest their fingers on the keyboard surface without triggering unintended inputs, so as to reduce fatigue during long typing sessions.
Efficient gesture and tap recognition:

Recognizing various gestures such as taps, swipes, long presses, and/or the like is important for virtual keyboards that need to support both typing and navigation functions. The virtual keyboards need to interpret gestures and taps accurately to ensure that users can switch between typing and other actions seamlessly without interference between the two.
Adaptability to various typing styles and environments:

The virtual keyboards need to adapt to different typing styles, such as two-handed, one-handed, stylus-based input, and/or the like. The virtual keyboards need to accommodate users who may switch between typing and other activities (such as operating a touchpad or mouse) and adjust accordingly for different device orientations (such as tablet mode, laptop mode, and/or the like).
Rest detection and anti-accidental touch filtering:

Accurately detecting resting fingers and filtering out of accidental touches is important for improving typing accuracy. The virtual keyboards need to identify light, unintended touches, and distinguish them from intentional actions such as keypresses or gestures. This need to be done without interrupting the natural typing flow, so as to allow users to type confidently without worrying about misfires.

With respect to accidental or unintentional touch in virtual keyboards, it is observed that multi-finger typing brings significant risks of accidental touches, especially when fingers lift off and return to the screen. These accidental inputs can occur when users attempt to move between typing and resting their hands, causing unintended key activations. Moreover, when fingers rest on the touch screen, they often generate accidental inputs. The system should be able to distinguish between these resting touches and active typing to reduce errors.

It is also observed that the most common unintentional touch patterns come from multiple fingers resting (82.90%), which includes users placing several fingers on the screen while they prepare to type or when switching between typing and other actions. Other unintentional touch behaviors include the hypothenar eminence (the soft area of the hand near the palm) touching the screen unintentionally (7.53%) and extra light touches (3.21%).

Various interaction scenarios where accidental touches are most likely to happen may be categorized as:
Two-Hands Typing: In continuous typing, the fingers can occasionally move off and return to the screen, increasing the chance of accidental touches.
Hovering Fingers: Non-continuous typing, where fingers are hovering or anchoring, often causes accidental touches when fingers transition from hovering to typing.
One-Hand Typing or Other Input Use: Typing with one hand while using the other for different input devices (like a trackpad) can result in accidental touches when switching between actions.
Both Hands Leaving and Returning to the Touch Surface: When both hands leave the touch screen and then return, the likelihood of accidental touches increases as the system may misinterpret the contact as active typing.

Thus, by focusing on resting fingers, light touches, and other subtle touch points, the virtual keyboards disclosed herein are carefully designed to filter out these accidental inputs, thereby providing improved resting finger detection and accidental touch filtering to enhance the user experience of virtual keyboards. The virtual keyboards disclosed herein allow dynamic adjustment based on the user's finger movements, resting behavior, and potential coactivation touch points to reduce errors and improve typing efficiency. In particular, the virtual keyboards disclosed herein focus on managing multi-finger input effectively while providing adaptive features that can adjust the layout or deactivate certain keys when resting fingers are detected.

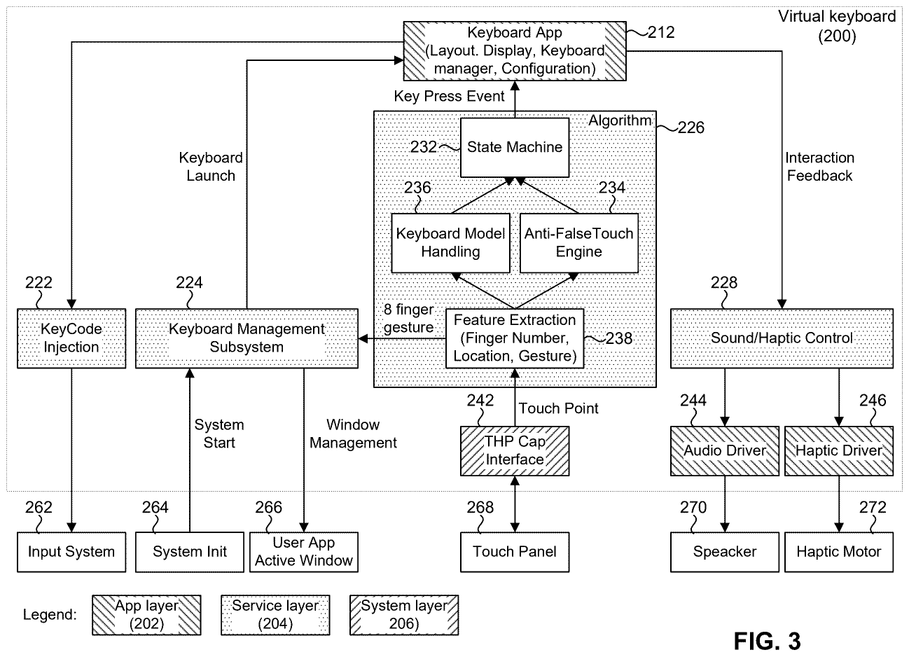

FIG. 3 is a schematic diagram showing the functional structure of the computing device 100 for implementing a virtual keyboard 200, according to some embodiments of this disclosure. As shown, the virtual keyboard 200 comprises a plurality functional blocks arranged in multiple layers for handling user input on the touch surface of a touch panel such as a capacitive touch panel and providing an adaptive, responsive typing experience. In the following, finger operations on the touch surface are used as examples of user input thereon. However, those skilled in the art will appreciate that the user input on the touch surface may also be other suitable types of touch input thereon such as operating a stylus, a pointer, or the like on the touch surface.

In these embodiments, the virtual keyboard 200 comprises three main layers: the app layer 202, the service layer 204, and the system layer 206.
App layer 202: Frontend and user interface (UI)

The app layer 202 comprises a virtual keyboard app 212 representing the UI of the virtual keyboard 200, where the layout and keyboard settings are configured and displayed. This layer handles the visual aspects of the keyboard, ensuring that the user interacts with a responsive and customizable virtual keyboard 200. The app 212 is responsible for adjusting the keyboard's layout based on different user preferences, such as language settings, key sizes, configurations, and/or the like. When a user presses a key, a corresponding keypress event is sent from the app layer 202 (or more specifically the app 212) to the system's underlying state machine 232 of the service layer 204, where the action is further analyzed and processed. Herein, a keypress event refers to a user-intended operation on one or more keys (such as pressing a key, pressing and holding a key, a gesture applied on or in proximity with the touch surface, and/or the like).
Service layer 204: Main processing and intelligence

The service layer 204 provides the main processing and intelligence of the virtual keyboard 200, which includes a keycode injection module 222, a keyboard management subsystem 224, main processing engines and algorithms module 226, and a sound/haptic control module 228.

When a keypress is validated and recognized by the system 100, the keycode injection module 222 receives keypress events from the virtual keyboard app 212, translates the touch interaction into corresponding commands such as actual keypress and/or system commands, and sends the commands to respective system components 262 (such as the operating system and/or active applications) for execution. This ensures that user inputs are correctly translated into letters, numbers, commands, and/or the like, making the virtual keyboard 200 functional within any software environment.

The keyboard management subsystem 224 manages the virtual keyboard 200 and handles system-level tasks such as launching or starting the virtual keyboard 200 after system initialization 264, managing the virtual keyboard window in the active application 266, and ensuring that the virtual keyboard 200 operates seamlessly in different user scenarios such as switching between tablet and laptop modes.

The processing engines and algorithms module 226 comprises a state machine 232 which is responsible for managing different states of the virtual keyboard 200, such as detecting keypresses, handling gestures, interpreting multi-touch inputs, and/or the like, and providing keypress events to the app 212. The state machine 232 determines when a touch should trigger a keypress event or when it should be ignored as an accidental touch.

The processing engines and algorithms module 226 also comprises an anti-false-touch engine 234 for applying advanced filtering mechanisms on extracted touch-related features (obtained from the feature extraction engine 238) to prevent unintended touches (such as fingers resting on the screen), and providing filtered touch-related features to the state machine 232. The anti-false-touch engine 234 differentiates between accidental touches and intentional gestures or key presses, allowing for a more seamless typing experience by eliminating false inputs.

In these embodiments, the position, structure, and/or layout of the virtual keyboard 200 may automatically change in accordance with the user's operation, or may change in response to the user's instruction. Accordingly, the processing engines and algorithms module 226 comprises a keyboard model handling component 236 for maintaining the overall structure and layout of the keyboard, and providing the position, structure, and/or layout information of the virtual keyboard 200 to the state machine 232, for ensuring that keys are positioned correctly and that multi-finger gestures (like swiping or pinching) are interpreted accurately.

The processing engines and algorithms module 226 also comprises a feature extraction engine 238, which analyzes incoming touch data to determine finger-related information such as the number of fingers contacting the touch surface, their positions, the types of gestures being performed, and/or the like, and sending the finger-related information to the anti-false-touch engine 234 and the keyboard model handling component 236. Thus, the feature extraction engine 238 allows for complex multi-touch gestures such as eight-finger typing to be recognized and processed without confusion. This finger-related information extraction process helps to enable more fluid interactions with the virtual keyboard 200, allowing for a greater range of gestures and improving overall user performance.
System layer 206: Hardware Interaction and Feedback

The system layer 206 is responsible for initializing the system and providing the infrastructure for the virtual keyboard 200 to function. It directly interacts with the hardware components of the virtual keyboard system 100, such as the touch panel 268, one or more speakers 270, one or more haptic motors 272, and/or the like, and comprises a touch host processing (THP) capacitive (cap) interface 242, an audio driver 244, and a haptic driver 246.

The THP cap interface 242 controls the touch panel 268 and acts as a bridge between the physical hardware and the virtual keyboard's processing components. When the user touches the screen, the touch panel 268 captures the input and sends it to the THP cap interface 242, which generates touch data and sends it to the feature extraction engine 238. The audio driver 244 controls the one or more speakers 270 for providing real-time audio feedback (such as playing key-press sound). The haptic driver 246 controls the one or more haptic motors 272 for providing real-time haptic feedback in response to various keypress events.

Such a real-time feedback mechanism ensures that users know their inputs have been registered. After the touch inputs are processed and a keypress is recognized, the virtual keyboard 200 sends signals to the audio driver 244 and haptic driver 246 to deliver sound and haptic feedback, respectively. This interaction enhances the typing experience by mimicking the physical sensation of typing on a mechanical keyboard, even though the user is typing on a flat, touch-sensitive surface.

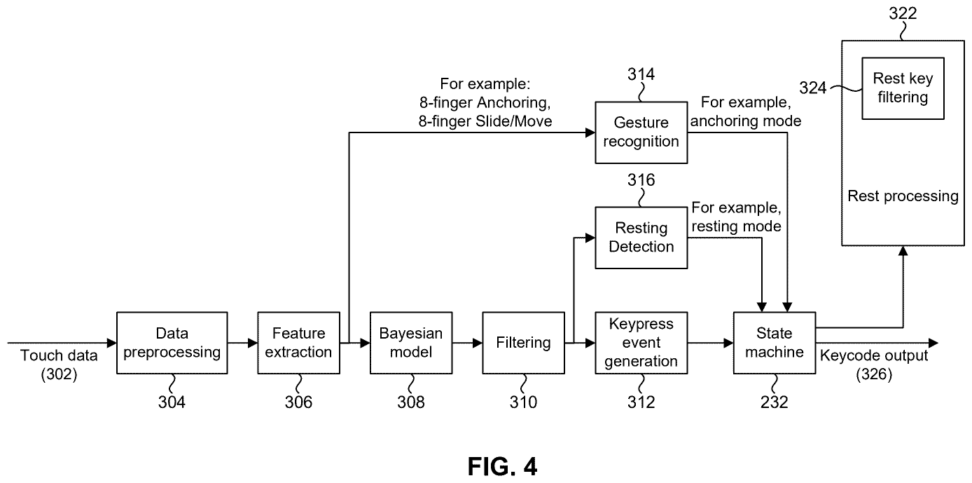

FIG. 4 is a schematic diagram showing the touch-point processing pipeline of the virtual keyboard 200 for converting raw touch data from a touch panel into valid keypress events while mitigating the effects of unintended touches, according to some embodiments of this disclosure.

When the touch panel (such as a capacitive touch panel) detects one or more touches, the raw touch data 302 captured from the touch panel is preprocessed (step 304) such as removing noise or irrelevant information that may hinder accurate touch detection, ensuring that the incoming data is in a format that the rest of the virtual keyboard 200 can process effectively, and/or the like.

At step 306, the preprocessed touch data is sent to the feature extraction engine 238 for identifying various characteristics of the touch events, such as the number of fingers contacting the touch surface, their locations, gestures being performed, and/or the like. Step 306 distinguishes touch data between intentional inputs such as taps or swipes, and unintentional contacts such as resting fingers.

A step 308, the touch data is analyzed using a suitable statistic model such as a Bayesian model, which applies probabilistic methods to predict the most likely user intentions based on the collected touch data. More specifically, it gives a probability for each potential key so the virtual keyboard system 100 may pick the one that has the highest probability as the user-intended key. In some embodiments, if the potential key with highest probability does not meet a minimum threshold, the virtual keyboard system 100 may consider that the use made an accidental touch (that is, none of the potential keys is considered the user-intended key). It is particularly useful for handling ambiguous touch events, such as when a user is hovering or resting their fingers near the keyboard. The Bayesian model helps improve accuracy by factoring in the likelihood of specific inputs, given the context of the user's previous interactions.

At step 310, the touch data is filtered based on the analysis result at step 310 for further refining the touch data and eliminating touches that are unlikely to be intentional inputs. This includes discarding light accidental touches, such as when the user brushes the screen or rests a finger without intending to type. The filtering step 310 ensures that only relevant and deliberate touches are passed on to the next stages of the system. The filtered touch data is then used for keypress event generation (step 312), gesture recognition (step 314), and resting detection (step 316)

At step 312, the filtered touch data is converted to keypress events. For instance, if the user touches the “A” key on the virtual keyboard, the corresponding touch data is registered as a valid “A” keypress event. Step 312 also handles more complex inputs, such as multi-finger gestures or rapid typing sequences.

At step 314, gesture recognition is also performed based on the filtered touch data to identify more advanced touch interactions, which include swiping, pinching, and other single-finer or multi-finger gestures that can be used to perform tasks beyond simple typing. For example, a three-finger swipe may be interpreted as a command to switch between applications. The gesture recognition step 314 ensures that the system responds appropriately to all forms of touch input, not just keypresses.

At step 316, resting detection is performed based on the filtered touch data to handle the issue of resting fingers. The virtual keyboard 200 continuously monitors whether fingers are resting on the touch surface without pressing any keys. If it detects a resting state, it temporarily disables keypress detection for those fingers to prevent accidental inputs. Therefore, this step is helpful for reducing user fatigue, as it allows users to rest their hands without causing unintended key presses.

The state machine 232 uses the results from steps 312 to 316 and coordinates the transitions between different touch states such as active touch, resting touch, and gesture recognition, to ensure that the virtual keyboard 200 behaves consistently regardless of the user's actions. The state machine 232 manages the flow of data between various components, modules, and steps, ensuring that each of them receives the correct information at the appropriate time.

Under the management of the state machine 232, rest processing (step 322) including rest key filtering (step 324) is performed once resting fingers are detected, to ensure that these touches corresponding to resting fingers are filtered out from the active keypresses. This prevents accidental key activations caused by resting fingers. Additionally, the rest processing 322 manages the transition between resting and active states. When a finger moves from a resting position to a keypress, the virtual keyboard 200 swiftly adjusts, reactivating key detection for that specific finger.

Once all touch events have been processed and filtered, the valid keypresses are converted into keycode output 326 for outputting keycodes to the operating system or application to perform the desired action such as typing a letter or executing a gesture command. Herein, a keycode is or representation or indication (such as a code) of a corresponding keypress event.

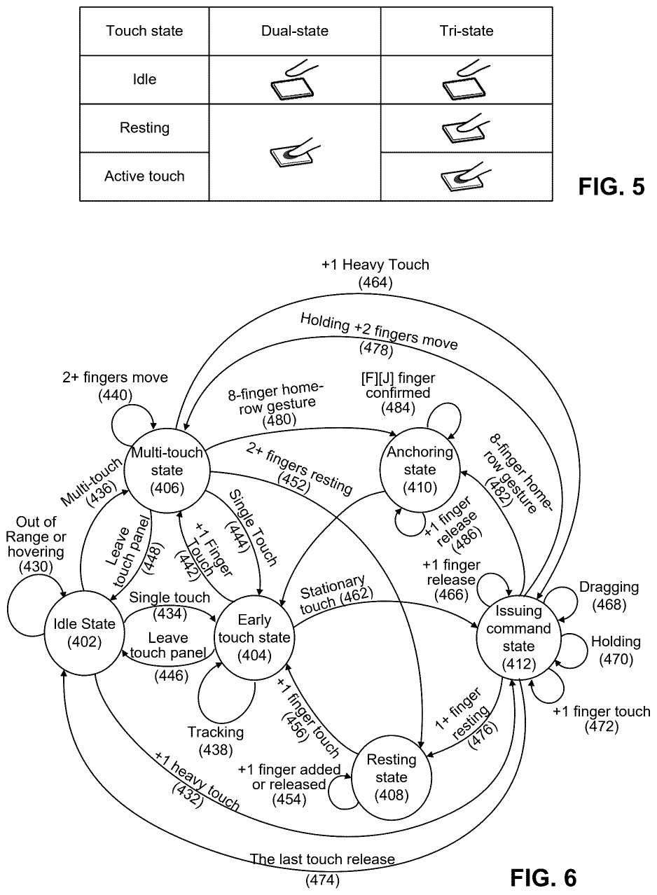

As shown in FIG. 5, in these embodiments, the virtual keyboard 200 uses three types of touch states (that is, tri-state) including:
Idle: No finger contacting with the touch surface.
Resting: Fingers contacting the touch surface but not actively engaging with any keys.
Active touch: One or more fingers pressing on one or more keys to activate the keys.

Compared to conventional methods that use two types of touch states (that is, dual-state), the tri-state provides improved avoidance of errors by distinguishing between accidental rests and intentional typing actions.

The active touch may be further partitioned into a plurality of states. For example, TABLE 1 (also see FIG. 6) shows the states used in some embodiments of this disclosure.

TABLE 1
VIRTUAL KEYBOARD STATES

| State | Definition | Functions |
|---|---|---|
| Idle (402) | No touch in virtual keyboard | Hovering, no touching |
| Early touch (404) | Active finger touch detected | Touch tracking |
| | and track | |
| Multi-touch (406) | More than 2 fingers in touch | Panning, |
| | | Pinching, |
| | | Tapping, |
| | | Shadow mouse, |
| | | Swiping |
| Resting (408) | All the fingers are in resting | Resting |
| Anchoring (410) | 8-finger in touch and move | Home-row anchoring, |
| | | Keyboard height |
| | | adjusting |
| Issuing command | Handle the keycode issuing | Tapping, |
| (412) | | Long press, |
| | | Dragging |

FIG. 6 is a state transition diagram of the state machine 232 for keyboard multi-finger rest and typing, according to some embodiments of this disclosure. Unlike traditional state machines that treat each touchpoint separately, the state machine 232 in these embodiments manages the entire keyboard globally. This means that the virtual keyboards 200 tracks and processes the state of all fingers on the keyboard collectively, which is important for multi-finger typing where resting and active touches occur frequently.

As shown, the virtual keyboard 200 is in the idle state 402 when no touch is detected thereon (430), meaning that the finger is out of range or hovering above the virtual keyboard 200. The virtual keyboard 200 may transition from the idle state 402 to the issuing command state 412 when a “heavy” touch (for example, a long press or a touch with increased pressure) is determined (432).

The virtual keyboard 200 transitions from the idle state 402 to the early touch state 404 (434) or the multi-touch state 406 (436) when a single touch or multiple touches are detected, respectively.

In the early touch state 404 or the multi-touch state 406, the virtual keyboard 200 tracks (438, 440) the movement of the single or multiple touches, and may transit from the early touch state 404 to the multi-touch state 406 when more than one touches are detected (4442), or transit from the multi-touch state 406 to the early touch state 404 when the multiple touches are reduced to a single touch (444).

When the single or multiple touches disappear (that is, the one or more fingers leave the touch surface), the virtual keyboard 200 transitions from the early touch state 404 or the multi-touch state 406 to the idle state 402 (446, 448), respectively.

In the early touch state 404 or the multi-touch state 406, the virtual keyboard 200 may determine that one or more fingers are resting (452) and transit to the resting state 408. The virtual keyboard 200 remains at the resting state 408 even if the number of resting figures is changed (454). However, if any of the resting figure is determined as a touch (456), the virtual keyboard 200 transitions from the resting state 408 to the early touch state 404.

In the early touch state 404, once the single touch is confirmed (462), the virtual keyboard 200 transitions to the issuing command state 412 to output keycodes, and may play animation, sound, gentle tap haptic, and/or the like as the user feedback.

In the multi-touch state 406, when a “heavy” touch is detected (464), the virtual keyboard 200 transitions to the issuing command state 412 to output keycodes, and may play animation, sound, gentle tap haptic, and/or the like as the user feedback.

In the issuing command state 412, the virtual keyboard 200 may determine touch changes such as one finger touch is released (466; that is, lifted), finger dragging (468), finger holding (470), one or more finger touches (472), and the virtual keyboard 200 may generate keycodes accordingly.

In the issuing command state 412, one or more finger touches may disappear or be released (that is, lifted). When the last finger touch is released (474), the virtual keyboard 200 transitions from the issuing command state 412 to the idle state 402.

Moreover, in the issuing command state 412, when any finger touch becomes resting (476), the virtual keyboard 200 transitions from the issuing command state 412 to the resting state 408.

In the issuing command state 412, when two or more fingers are held on the touch surface and moving (478), the virtual keyboard 200 transitions from the issuing command state 412 to the multi-touch state 406.

In the multi-touch state 406 or the issuing command state 412, when an eight-finger home-row gesture is performed (480, 482; described in more details later), the virtual keyboard 200 transitions to the anchoring state 410.

In the anchoring state 410, when the user rests fingers on the “anchor” keys (such as the home-row keys such as the F and J keys) (484), the virtual keyboard 200 stays in the anchoring state 410.

In the anchoring state 410, if one finger touch is released (486), the virtual keyboard 200 stays in the anchoring state 410.

Thus, the state machine 232 supports smooth transitions between various multi-finger typing states. For instance, when a user rests fingers on the touch surface, types, and transitions back to resting, the virtual keyboards 200 intelligently switches between these states to maintain accuracy and prevent accidental input.

The virtual keyboard 200 in these embodiments provides an anchoring state 410 to adapt the keyboard to fit the user's natural hand posture. When the user rests fingers on the “anchor” keys (such as the home-row keys such as the F and J keys), the virtual keyboard 200 adapts to adjust the keyboard layout dynamically or move it (also denoted “adjusting height” of the virtual keyboard 200 along the vertical direction of the touch surface) to suit the user's finger positions.

The state machine 232 handles multi-touch inputs and allows for the simultaneous processing of keypresses and touch-surface gestures. This feature ensures smooth transitions between typing and navigation tasks, which is particularly useful in tablet and foldable PC contexts.

In some embodiments, when a heavy touch (such as a long press or a touch with increased pressure) is detected, the virtual keyboard 200 transitions immediately to the issuing command state 412. This state 412 enables actions such as issuing specific commands or triggering shortcuts, improving the efficiency of power users who often rely on such gestures.

In some embodiments, to ensure that resting fingers do not cause accidental input, the virtual keyboard 200 delays key activation until a “touch-up” event is detected, allowing enough time to differentiate between rest and intentional keypresses. This approach accommodates the natural resting periods that occur during typing and ensures accurate input registration.

In some embodiments, the virtual keyboard 200 uses an anchoring mechanism. Herein, anchoring is the action where users position their fingers on specific keys (such as the F and J keys, commonly known as home-row anchors). The virtual keyboard 200 detects when all eight fingers are in place and uses this input to improve accuracy and minimize errors, such as accidental touches or unintentional key presses. Anchoring stabilizes the virtual keyboard state and adapts to the user's typing posture.

Anchoring is useful when the user rests their fingers on the home row of keys. For example, the F and J keys are important because users often use them as reference points for touch typing. When the system detects the fingers are anchored in this way, it can ensure proper alignment, reducing input errors.

As shown in FIG. 6, the anchoring event triggers a transition to the “anchor state” within the state machine 232 which manages the overall typing behavior. This state allows the virtual keyboard 200 to process key alignment or perform adjustments such as moving the virtual keyboard vertically (up/down) along the touch surface based on user input, which provides a personalized and error-free typing experience.

Once the fingers are detected as anchored, the virtual keyboard 200 calculates motion direction angles based on finger movement. If the detected motion angle is close to 90° or 270° degrees, the virtual keyboard 200 is adapted, either by commands to reposition it or by gestures such as swipes or key adjustments. This feature ensures fluidity in typing and supports quick gesture-based actions.

In some embodiments the virtual keyboard 200 includes a debounce mechanism (such as with a 50 milliseconds (ms) timer) to verify that the touch event is stable before being classified as an anchor event. This prevents misinterpretations caused by accidental light touches or brief taps, ensuring the system only recognizes deliberate input.

If the conditions for anchoring are met, the state machine 232 transitions into the resting state 408 or the anchoring state 410, depending on whether the user continues typing or adjusts their hand position. The resting state 408 accommodates scenarios where users are not actively typing, ensuring that resting fingers do not trigger accidental inputs.

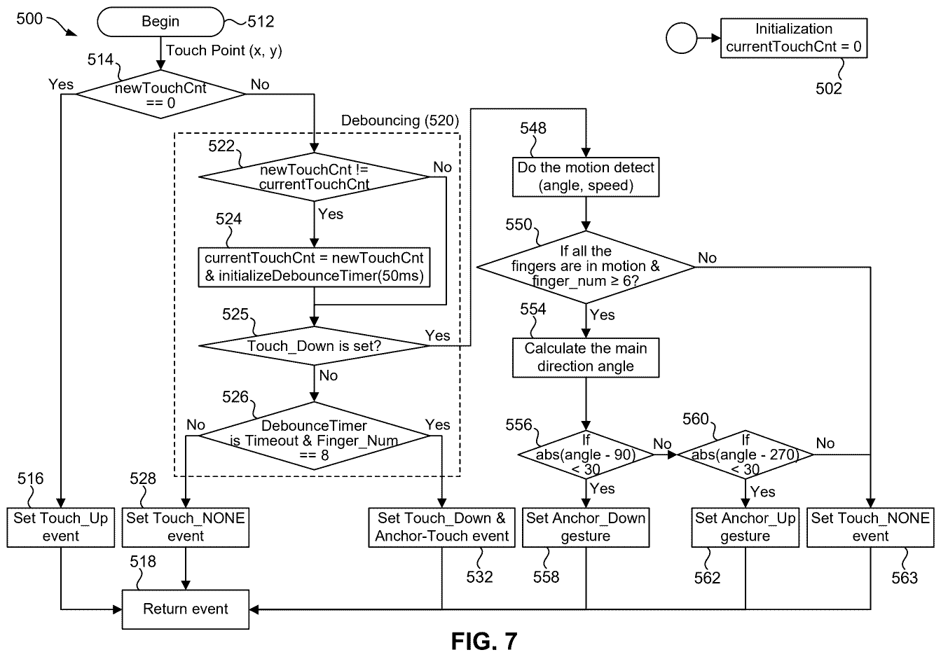

FIG. 7 is a flowchart showing the steps of an anchoring detection procedure 500 executed by the virtual keyboard 200, according to some embodiments of this disclosure.

Before the procedure 500 starts, the virtual keyboard 200 initializes the current number of touches (denoted “currentTouchCnt”) to zero (0) (step 502).

When the procedure 500 starts (step 512), the virtual keyboard 200 sends the coordinates (x, y) of one or more new touch points to the procedure 500. At step 514, the procedure 500 check if the number of new touches is zero (0). If the number of new touches (denoted “newTouchCnt”) is zero (0), a Touch_Up event is set (step 516; meaning touches are lifted), and the procedure 500 returns the event (step 518).

If at step 514, the number of new touches is not zero (0), the new touches are processed for debouncing (520). More specifically, at step 522, the procedure 500 checks if the number of new touches is different to the current number of touches (that is, checking if newTouchCnt!=currentTouchCnt). If the number of new touches equals to the current number of touches, the procedure 500 goes to step 525.

If at step 522, the number of new touches is different to the current number of touches, the current number of touches is set to the number of new touches (that is, currentTouchCnt=newTouchCnt), and a debounce timer (such as a 50 ms timer is inititalized (that is, initializeDebounceTimer(50 ms)) (step 524).

At step 525, the procedure 500 checks if Touch_Down event is set. If yes, the procedure 500 goes to step 548.

If at step 525, it is determined that the Touch_Down event is not set, the procedure 500 checks the debounce timer and the number of touches (that is, finger_num, which is the current number of touches currentTouchCnt) (step 526).

If the debounce timer is not timeout or finger_num is not equal to eight (8), the procedure 500 sets the Touch_NONE event (step 528; that is, touch event not determined yet), and the procedure 500 returns the event (step 518).

If at step 526, it is determined that the debounce timer is timeout and finger_num equal to eight (8), the procedure 500 sets a Touch_Down event and an Anchor-Touch event (step 532), and the procedure 500 returns the event (step 518).

Recall that, at step 525, if the Touch_Down event is set, the procedure 500 goes to step 548. At step 548, the procedure 500 executes motion detection to detect the angle and speed of the touches.

At step 550, the procedure 500 checks if all the touches are in motion and if finger_num is greater than or equal to six (6). If not all touches are in motion or if finger_num is less than six (6), the procedure 500 sets the Touch_NONE event (step 563) and returns the event (step 518).

If at step 550, it is determined that all touches are in motion and finger_num is greater than or equal to six (6), then the procedure 500 calculates the main direction angle of the movement of the eight touches (step 554).

At step 556, the procedure 500 checks if the main direction angle is within a predefined angular range (such as 30°) around the downward direction (for example, the 90° vertical angle) of the touch surface. If the main direction angle is within the 30° range around the downward direction of the touch surface, the Anchor_Down gesture is set (step 558), meaning that the user is moving the virtual keyboard downwardly along the vertical axis of the touch surface, and the procedure 500 returns the Anchor_Touch event and the Anchor_Down gesture (step 518).

If at step 556, the main direction angle is outside the 30° range around the upward direction of the touch surface, the procedure 500 checks if the main direction angle is within a predefined angular range (such as 30°) around the upward direction (for example, the 270° vertical angle) of the touch surface (step 560). If the main direction angle is within the 30° range around the upward direction of the touch surface, the Anchor_Up gesture is set (step 562), meaning that the user is moving the virtual keyboard upwardly along the vertical axis of the touch surface, and the procedure 500 returns the Anchor_Touch event and the Anchor_Up gesture (step 518).

If at step 560, the main direction angle is outside of the 30° range around the upward direction of the touch surface, the procedure 500 sets the Touch_NONE event (step 563) and returns the event (step 518).

In some embodiments, the virtual keyboard 200 uses a resting detection method, which focuses on solving the challenge of distinguishing between intentional keypresses and resting touches on the virtual keyboard 200. This method is important for improving typing accuracy by preventing accidental inputs when the user rests fingers or palms on the touch surface.

In these embodiments, the resting detection method uses a timing-lock model having a predefined or preconfigured resting time threshold to classify touches as either active input or resting. If a touch exceeds the resting time threshold without movement, the virtual keyboard 200 interprets it as a resting touch rather than a keypress. This model ensures that long, unintended touches do not trigger accidental keystrokes.

In some embodiments, the virtual keyboard 200 also uses a sequential touch model, wherein, when multiple fingers sequentially make contact with the touch surface, the virtual keyboard 200 classifies these sequential touches as natural resting behavior. The sequential touch model is to handle complex finger interactions, ensuring accurate classification between rest and active input during typing.

More specifically, the virtual keyboard 200 takes into account various behaviors of resting fingers based on various user interactions, to adapt to different scenarios:
Simultaneous finger resting: When all fingers contact the touch surface at the same time and remain in contact past the resting time threshold, the virtual keyboard 200 enters the resting state 408, which prevents the virtual keyboard 200 from interpreting these touches as active input, thereby reducing accidental key presses.
Sequential finger resting: If multiple fingers (such as greater than or equal to three fingers) touch the screen sequentially, the virtual keyboard 200 treats these sequential touches as a resting action. The virtual keyboard 200 checks whether the fingers belong to one or both hands, and determines if they are in resting mode or are part of an active keypress sequence.
Two-finger resting: In cases where two fingers contact the touch surface in quick succession (such as within 30 ms), the virtual keyboard 200 identifies them as resting fingers, provided that they remain within the resting time threshold.
Single finger resting: When a single touch lasts more than a predefined or preconfigured single-figure resting time threshold (such as 500 ms), the virtual keyboard 200 classifies the single touch as resting (or a long press), minimizing unintended inputs during pauses or adjustments in typing.

In some embodiments, the virtual keyboard 200 detects palm resting, that is, the scenario where the user rests one or two palms on the touch surface while typing.

In some embodiments, the virtual keyboard 200 uses a palm detection method to detect palms resting on the touch surface but outside the keyboard typing area, and exclude the detected palms from keypress recognition, thereby significantly reducing errors and improving the overall typing experience.

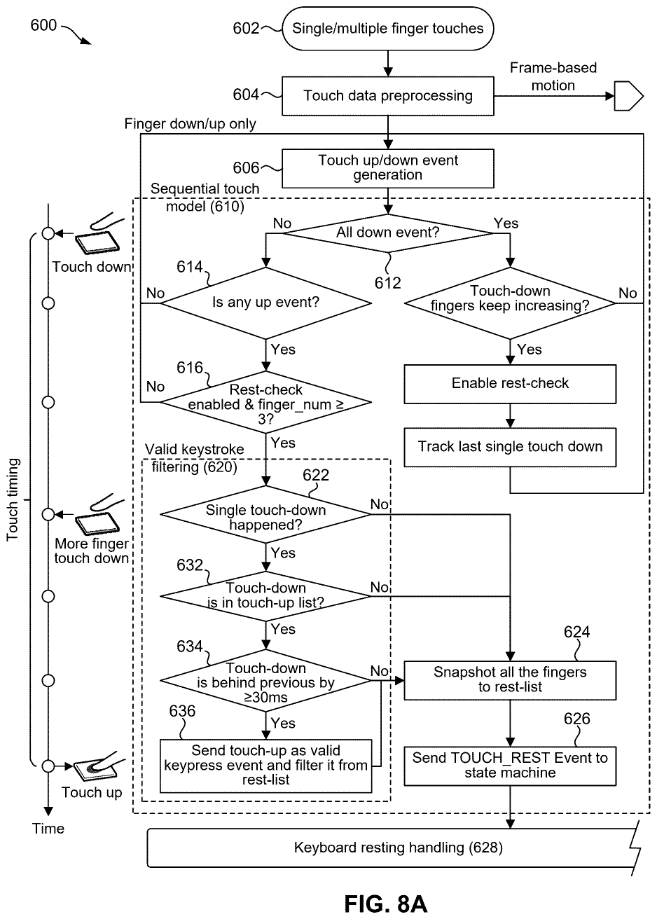

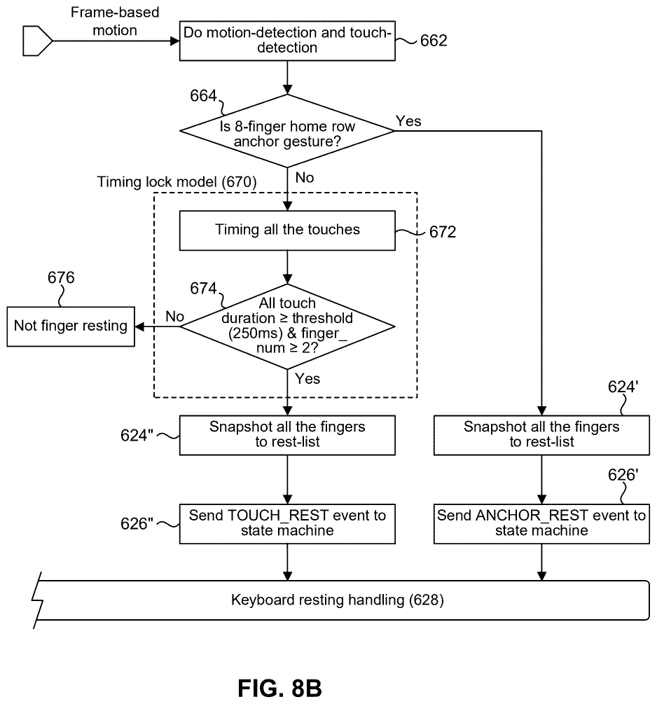

FIGS. 8A and 8B show a flowchart illustrating the resting detection method 600, according to some embodiments of this disclosure.

At step 602, single or multiple touches are detected. At step 604, the touch data is preprocessed. The preprocessed touch data is the processed along two processing paths.

In the first path, the virtual keyboard 200 generates one or more touch events (step 606), each of which may be a Touch_Up event or a Touch_Down event. Then, the virtual keyboard 200 uses the sequential touch model 610 to process the one or more touch events.

More specifically, at step 612, the procedure 600 checks if all events generated at step 606 are Touch_Down events. If not all events are Touch_Down events, the procedure 600 checks if any event generated at step 606 is a Touch_Up event (step 614). If no event is a Touch_Up event, then the procedure 600 goes back to step 606.

If at step 614, it is determined that at least one of the touch events is a Touch_Up event, then the procedure 600 checks if the rest-check (which is a flag) is enabled and whether the number of touches (that is, finger_num) is greater than or equal to three (3) (step 616). If the rest-check is not enabled or finger_num is less than three (3), the procedure 600 goes back to step 606.

If at step 616, the rest-check is enabled and finger_num is greater than or equal to three (3), the procedure 600 performs valid keystroke filtering (620).

More specifically, the procedure 600 checks if only a single Touch_Down is generated at step 606 (step 622). If not, the procedure 600 includes (that is, snapshots) all touches into a rest-list (step 624), wherein the rest-list stores the touches that are determined as in the resting state 408.

The procedure 600 then sends a TOUCH_REST event to the state machine 232 to transition the touches to the resting state 408 (step 626), and allow the virtual keyboard 200 to handle the figure resting (step 628).

If at step 622, it is determined that only a single Touch_Down is generated at step 606, the procedure 600 checks if the Touch_Down event is in a touch-up list (which is a list for deciding the keystroke) (step 632). If not, the procedure 600 includes (that is, snapshots) the touch into the rest-list (step 624).

If at step 632, it is determined that the Touch_Down event is in the touch-up list, then the procedure 600 checks if the Touch_Down event occurs after the previous event by at least a predefined time threshold such as 30 ms (step 634). If not, the procedure 600 includes (that is, snapshots) the touch into the rest-list (step 624).

If at step 634, it is determined that the Touch_Down event occurs after the previous event by at least a predefined time threshold, the procedure 600 sends the touch-up as a valid keypress event and excludes it from the rest-list (step 636), and then goes to step 624.

The second path (see FIG. 8B) uses the frame-based motion detection (that is, in each frame (which is every touch panel reading; for example, the touch panel may be read at 125 frames per second), checking all finger touches and determine whether they are touch down, touch up, or touch move). At step 662. the virtual keyboard 200 executes motion-detection and touch-detection. Then, the procedure 600 checks if the touch data obtained after preprocessing (at step 604) represents the eight-finger home-row anchor gesture (step 664). If yes, the procedure 600 includes (that is, snapshots) all touches into a rest-list (step 624′), sends a TOUCH_REST event to the state machine 232 to transition the touches to the resting state 408 (step 626′), and allows the virtual keyboard 200 to handle the figure resting (step 628).

If at step 664, the touch data obtained after preprocessing does not represent the eight-finger home-row anchor gesture, the virtual keyboard 200 uses the timing lock model 670 to process the one or more touch events.

More specifically, the virtual keyboard 200 uses the timing of all touches (step 672), and checks if the duration of each touch is greater than or equal to a predefined or preconfigured time threshold such as 250 ms, and if finger_num is greater than or equal to two (2) (step 674). If the duration of each touch is less than a predefined or preconfigured time threshold such as 250 ms, or finger_num is less than two (2) (that is, a single touch), the touch is not a resting touch (step 676).

If at step 674, it is determined that the duration of each touch is greater than or equal to a predefined or preconfigured time threshold such as 250 ms, and finger_num is greater than or equal to two (2), the procedure 600 includes (that is, snapshots) all touches into a rest-list (step 624″), sends a TOUCH_REST event to the state machine 232 to transition the touches to the resting state 408 (step 626″), and allows the virtual keyboard 200 to handle the figure resting (step 628).

In some embodiments, the virtual keyboard 200 uses an accidental touch filtering method, which focuses on improving the accuracy of touch-based interactions on the virtual keyboard 200 by addressing two specific issues:
coactivation touches (that is, multiple fingers interacting simultaneously), and
light, unintended touches.

The accidental touch filtering method leverages virtual pressure modeling and hand geometry recognition to enhance the touch detection, particularly solving the issues causing the failure of the traditional methods that are based on touchpoints alone (x, y coordinates).

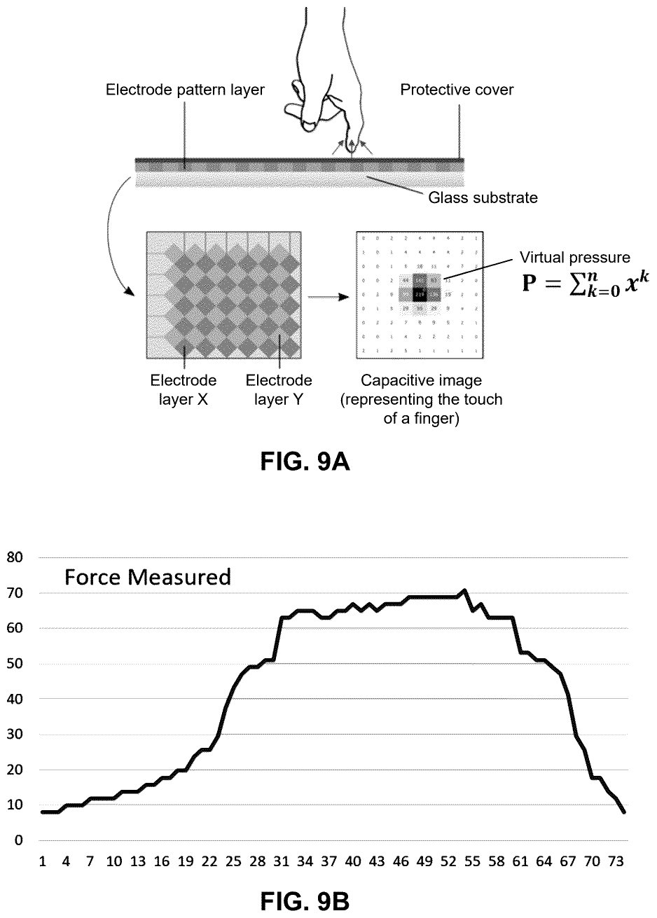

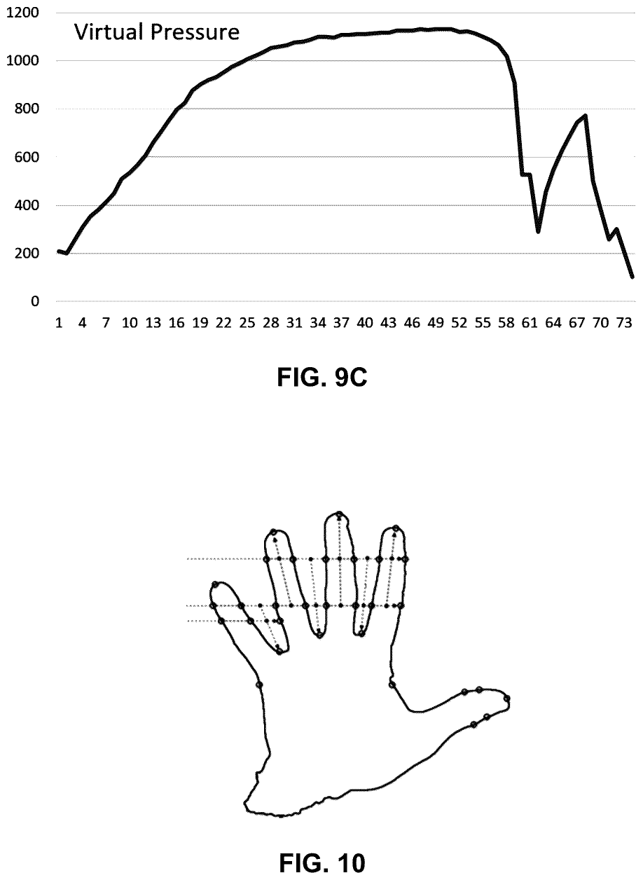

Herein, the term “virtual pressure” refers to the pressure of a touch applied to the touch surface, which may be the actually measured pressure, or a pressure derived from the touch panel in response to the touch. For example, in some embodiments, the accidental touch filtering method may be used with capacitive touch surfaces wherein the capacitance at the touch point changes in accordance with the pressure applied at the touch point (see FIGS. 9A to 9C), which may be used to derive the touch pressure.

In these embodiments, the accidental touch filtering method uses the virtual pressure to distinguish between intentional key presses and unintentional light touches. The accidental touch filtering method also uses hand geometry such as hand size, finger positions, maximum distances between different fingers of the same hand, and/or the like (see FIG. 10) to further enhance the detection accuracy.

Accidental touches may occur when multiple fingers interact with the touch surface at the same time. In these embodiments, the accidental touch filtering method compares the virtual pressure of different touchpoints to filter out unintended coactive touches. This process allows the virtual keyboard 200 to detect which finger applied a greater force and classify that as the intended touch, while filtering out the lighter, less deliberate touches that occur simultaneously.

As those skilled in the art will appreciate, light touches are a common source of error in virtual keyboards, especially when users rest their fingers lightly on the touch surface. The accidental touch filtering method applies a pressure threshold to detect and discard these light touches. It ensures that only touches with sufficient force are recognized as valid inputs, thereby significantly reducing accidental activations caused by resting fingers or incidental contact.

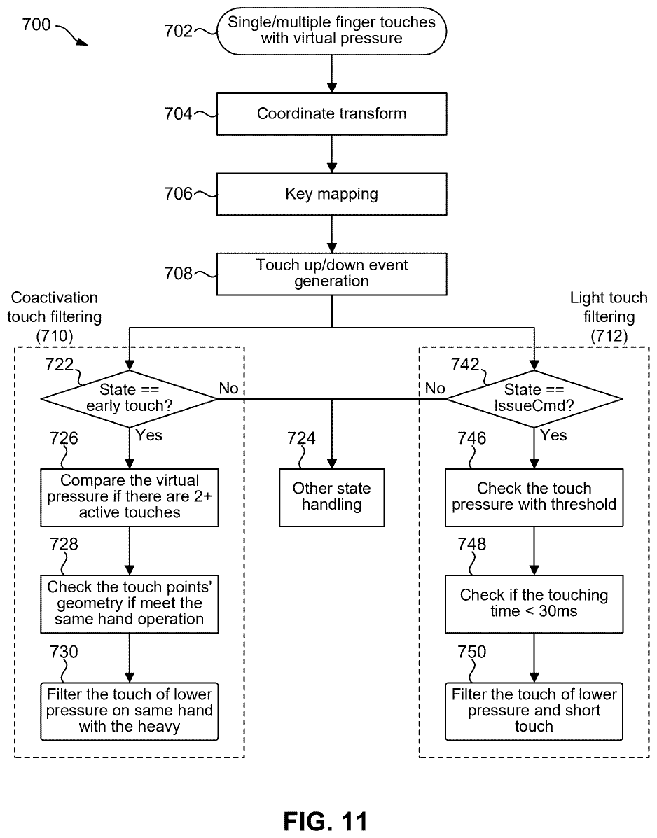

FIG. 11 is a flowchart showing a procedure 700 of filtering accidental touches for filtering coactivation touch and light touch, according to some embodiments of this disclosure.

At step 702, the virtual keyboard 200 detects one or more finger touches with measurements or estimations of the virtual pressures of the finger touches. At step 704, the coordinates of the one or more finger touches are transformed from the two-dimensional (2D) coordinate system with respect to the touch surface to a 2D coordinate system with respect to the layout of the virtual keyboard 200. Then, key mapping is performed (step 706) to map the one or more finger touches to various keys overlapping therewith, and Touch_Up and/or Touch_Down events are generated (step 708). Then, the procedure 700 performs coactivation touch filtering (710) and light touch filtering (712).

In coactivation touch filtering (710), the procedure 700 checks if there are two or more active touches and if the current state is the early touch state (step 722). If there is only a single touch or the current state is not the early touch state, then the one or more finger touches are processed for other state handling (step 724).

If at step 722, it is determined that the current state is the early touch state, then the procedure 700 checks the virtual pressure of each touch (step 726) and checks the geometry of the one or more touches to determine if the one or more touches correspond to a same hand (step 728). At step 730, the touches from the same hand and of low pressure (such as the virtual pressures thereof being lower than a predefined or preconfigured pressure threshold) are determined as coactivation touch and are filtered or otherwise removed.

In light touch filtering (712), the procedure 700 checks if the current state is the issuing command state 412 (step 742). If not, the one or more finger touches are processed for other state handling (step 724).

If at step 742, it is determined that the current state is the issuing command state 412, the procedure 700 then checks the virtual pressure of each touch (step 746) and check the duration of each touch (step 748). At step 750, light touches (such as touches with the virtual pressures thereof smaller than a predefined or preconfigured threshold) with short duration (such as touches with the durations thereof shorter than a predefined or preconfigured threshold such as 30 ms) are determined as light touch and are filtered or otherwise removed.

Some examples of the virtual keyboard 200 are now described.

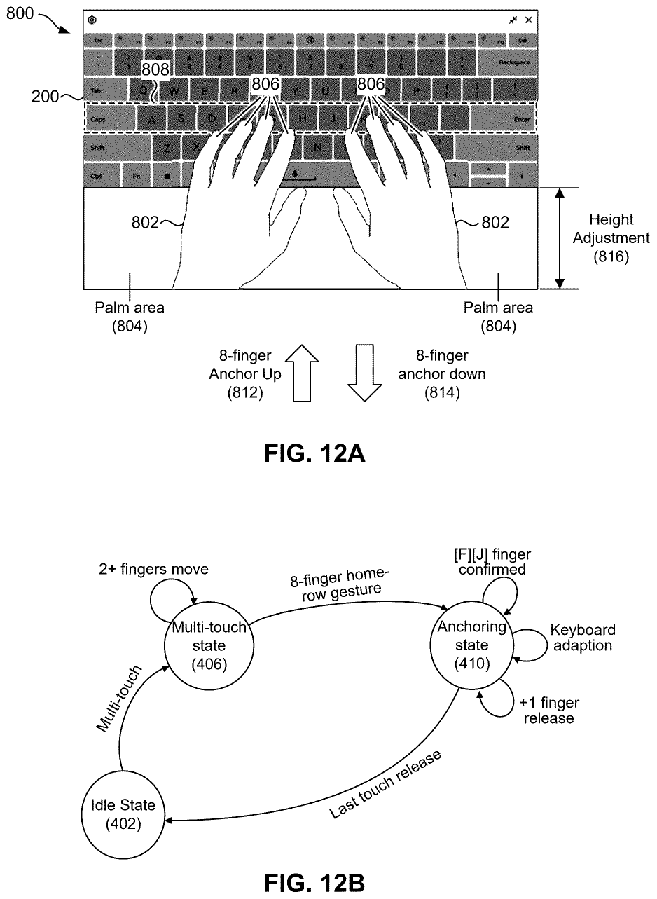

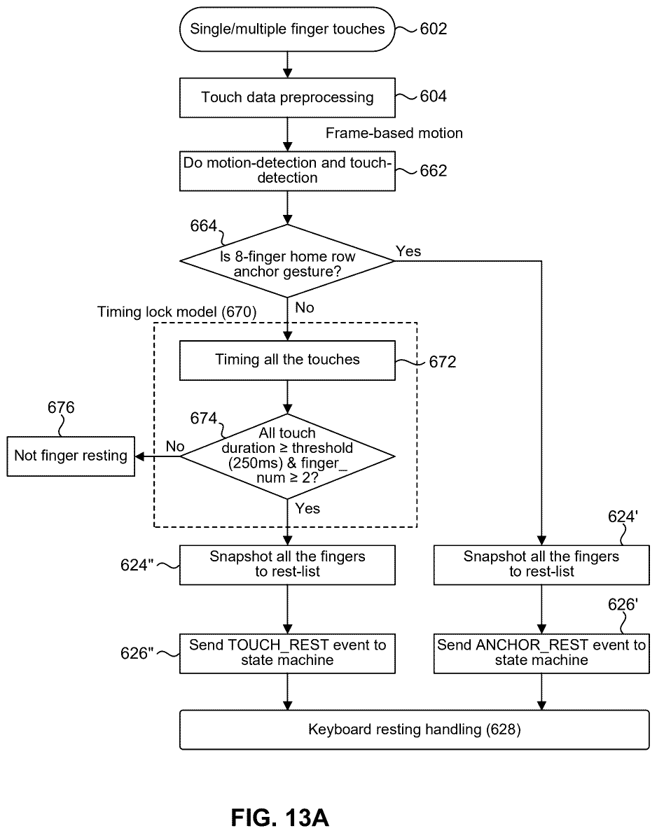

FIG. 12A shows an example of keyboard typing with palm resting supported by anchoring state's keyboard height adjustment. As shown, a virtual keyboard 200 is display on a touchscreen 800. A user (not shown) may use fingers of both hands 802 to type on the virtual keyboard 200 while resting the palms on the touchscreen 800 without triggering unintentional inputs, thereby addressing the common problem of accidental touch in multi-finger input systems.

In this example, the touchscreen 800 is partitioned into the area for the virtual keyboard 200 and a palm area 804 adjacent a near side of the virtual keyboard 200 (wherein the near side is defined as the side close to the user where the hands 802 are extended therefrom), allowing the user to rest the palms comfortably during typing, thereby reducing hand fatigue caused by hovering fingers. The palm area 804 is configured to differentiate between active touch inputs and resting palms, ensuring smooth typing without accidental inputs.

The user may use the eight-finger home-row activation gesture by placing eight fingers 806 on the touchscreen 800 to initiate the virtual keyboard 200 on touchscreen 800 with the home row 808 thereof positioned in accordance with the positions of the eight figures 806.

The user may use the eight finger touches to move the virtual keyboard 200 “up” (812) and “down” (814) (that is, moving the virtual keyboard 200 closer to the near side or further thereto) to adjust (816) the “height” of the palm area 806, so as to accommodate different hand positions and ensure ergonomic typing comfort. The user may lower or raise the keyboard based on their preference or the position of their device, making it adaptable for various postures (for example, typing on a desk or lap).

The state transition diagram of this example is shown in FIG. 12B, which involves:
Idle state 402: No touch inputs are detected.
Multi-touch state 406: The user places more than two fingers on the virtual keyboard 200, entering an active typing mode.
Anchoring state: The user may engage in an eight-finger home-row touch to adjust the virtual keyboard 200 based on the anchor's height.

When fingers are lifted or a gesture is completed, the virtual keyboard 200 transitions back to the idle state 402.

Those skilled in the art will appreciate that, in various use scenarios, finger resting and palm resting may occur at the same time or at different times, and resting detection shall detect both. In some embodiments, the virtual keyboard 200 accurately distinguishes between resting finger touches and palm touches during keyboard operation. This distinction is important for preventing unintended key activations while also supporting seamless typing actions.

In these embodiments, when a single finger touch remains pressed for more than a predefined or preconfigured threshold such as 500 ms, the finger touch is considered a long keypress. The virtual keyboard 200 processes this finger touch as a LONGKEY_DOWN event followed by a LONGKEY_UP event once the finger is lifted.

On the other hand, if a single finger touch is maintained on the touch surface for less than a predefined or preconfigured threshold such as 500 ms, the virtual keyboard 200 processes this finger touch as a KEY_DOWN event followed by a KEY_UP event, indicating a quick keypress that is registered as an intentional typing action.

When two fingers contact the touch surface simultaneously for more than a predefined or preconfigured threshold such as 250 ms, the virtual keyboard 200 classifies these two touches as resting keys. No keypress events are triggered, as the virtual keyboard 200 recognizes this as resting behavior rather than typing.

Similar to the two-finger scenario, when three or more fingers remain in contact with the touch surface for more than a predefined or preconfigured threshold such as 250 ms, these touches are identified as resting keys. No keypress events are generated to prevent accidental input.

If two fingers contact the touch surface in quick succession with a time interval of less than a predefined or preconfigured threshold such as 30 ms between the two touches, the virtual keyboard 200 detects these two touches as resting keys, meaning that the user is resting rather than typing.

If multiple fingers contact the touch surface sequentially and are then lifted, the virtual keyboard 200 considers these touches as resting, thereby ensuring that no keypress events are generated.

When the user places a palm on the touch surface, the virtual keyboard 200 identifies the palm as a non-active input, and rejects palm touches entirely, thereby preventing accidental keypresses or unintended behavior caused by resting palms on the surface.

In some embodiments, the virtual keyboard 200 uses a detailed logic to classify resting and typing behavior based on the timing and number of fingers in contact with the touch surface. TABLE 2 shows the above-described scenarios, specifying how the virtual keyboard 200 responds to various touch events:
Outputting LongKey Event (LONGKEY_DOWN, LONGKEY_UP) for longer single-finger presses.
Outputting Key Event (KEY_DOWN, KEY_UP) for intentional typing with short single-finger touches.
No event output for multi-finger resting touches or quick successive touches that indicate resting rather than typing.

TABLE 2
FINGER TOUCH SCENARIOS

| No | Scenarios | Resting Detection and Behavior | Function |
|---|---|---|---|
| 1 | Single Finger Long | The finger touch Long Key | LONGKEY_DOWN, |
| | Press >= 500 ms | (press time >= 500 ms) | LONGKEY_UP |
| | | The finger touch Long Key | KEY_DOWN, |
| | | (press time < 500 ms) | KEY_UP |
| 2 | Two Fingers Long Touch at | Finger touches are considered as | NO KEY EVENT OUT |
| | the same time >= 250 ms | Resting Keys | |
| 3 | 3+ Fingers Long Touch at the | Finger touches are considered as | NO KEY EVENT OUT |
| | same time for >=250 ms | Resting Keys | |
| 4 | Two Fingers from one hand | Finger touches are considered as | NO KEY EVENT OUT |
| | and touch down interval < | Resting Keys | |
| | 30 ms | | |
| 5 | Multi-fingers touch | Finger touches are considered as | NO KEY EVENT OUT |
| | sequentially and then take up | Resting Keys | |
| 6 | Palm on touchscreen | Palm will be rejected and no | No active finger touch |
| | | active finger touch to issue | to issue the key event |

In some embodiments, the virtual keyboard 200 rejects palm touches, ensuring that no active finger input is mistaken or blocked by palms resting on the touchscreen. This ensures a smooth typing experience even when users rest their hands on the screen.

In some embodiments, the virtual keyboard 200 adapts to various touch scenarios. TABLE 3 lists some touch scenarios.

TABLE 3
FINGER TOUCH SCENARIOS

| | | \textcircled{2} | \textcircled{3} | \textcircled{4} | \textcircled{5} | \textcircled{7} | \textcircled{8} | \textcircled{9} | \textcircled{10} |
|---|---|---|---|---|---|---|---|---|---|
| Typical | \textcircled{1} | palms + | palms + | one | two | four | five | eight | ten |
| Scenario | palms | 5 fingers | 10 fingers | finger | fingers | fingers | fingers | fingers | fingers |
| Fingers | / | 5 | 10 | 1 | 2 | 4 | 5 | 8 | 10 |
| Palms | Yes | Yes | Yes | / | / | / | / | / | / |

In these embodiments, the touch scenarios may be categorized based on the number of fingers and palms in contact with the touch surface; for example:
the system distinguishes between typing scenarios involving one or two fingers, and scenarios where five, eight, or ten fingers are in contact with the touch surface (which generally indicate the resting behavior);
when the user rests palms on the touch surface (with or without finger touches), the virtual keyboard 200 accurately detects these actions and ensures that palm touches do not interfere with typing.

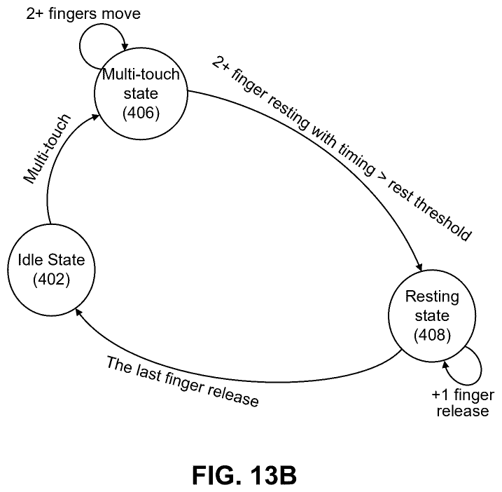

In one example, the virtual keyboard 200 performs resting detection with finger touch at the same time, wherein the virtual keyboard 200 focuses on identifying scenarios where multiple fingers make contact with the touch surface simultaneously, and differentiating the resting touches from active typing or gestures. This is important for preventing unintentional keypresses and improving user typing efficiency. The flowchart is shown in FIG. 13A, which is similar to the frame-based motion detection portion shown in FIG. 8B.

In this example, the virtual keyboard 200 uses frame-based motion detection. More specifically, the virtual keyboard 200 first analyzes whether multiple fingers are contacting the touch surface and then processes these touches using frame-based motion detection, wherein the virtual keyboard 200 determines whether the fingers are in motion or stationary, which helps to differentiate between active typing gestures and resting fingers.

In this example, the virtual keyboard 200 also performs debounce and touch detection, wherein the virtual keyboard 200 checks if any significant touch motion occurs. If motion is detected, the virtual keyboard 200 continues processing the touch as an active interaction. If no motion is detected, the virtual keyboard 200 enters a resting state after a predefined or preconfigured threshold time, thereby identifying the touch as a resting behavior.

In this example, a timing mechanism is applied to all detected touches. If the virtual keyboard 200 identifies that the touches have remained in place for a period exceeding a predefined or preconfigured threshold, the touches are classified as resting. This ensures that accidental or temporary touches are not misclassified as resting input.

In this example, once all conditions for resting detection are satisfied, the virtual keyboard 200 sends a TOUCH_REST event to the state machine 232, which processes the touch data accordingly, handling the resting input instead of issuing keypress events.

The state transition diagram is shown in FIG. 13B, which involves transition between the following states based on user input:
Idle state 402: The virtual keyboard 200 remains in this state when no active touches or significant finger movement is detected. The idle state 402 represents the base state when the user is not interacting with the virtual keyboard 200.
Multi-touch state 406: The virtual keyboard 200 transitions to this state when two or more fingers contact the touch surface simultaneously. In this state, the virtual keyboard 200 determines whether the input is an active touch or if the fingers are resting on the touch surface.
Resting state 408: If the virtual keyboard 200 detects that the fingers have remained in place for a specified duration without any movement (subject to a resting threshold), it transitions to the resting state 408, wherein the touch is recognized as a resting behavior and is refrained from generating keypress events.

The virtual keyboard 200 returns to the idle state 402 when the resting fingers are released, ensuring that further input is handled appropriately.

In this example, the virtual keyboard 200 may be used in various scenarios. For example, in one scenario, the virtual keyboard 200 identifies two simultaneous finger touches that remain on the touch surface for more than 250 ms as resting keys. No keypress events are generated in this scenario.

In another scenario where three or more fingers remain in contact with the touch surface for more than 250 ms, the virtual keyboard 200 detects this as a resting event. This prevents unintentional keypresses during periods when the user is resting their hands on the touch surface.

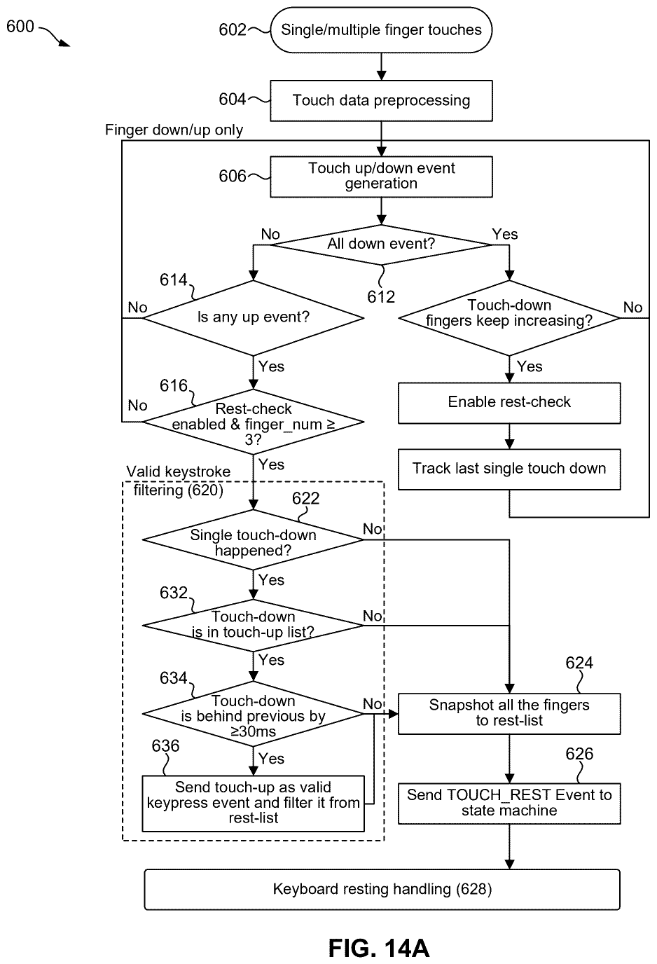

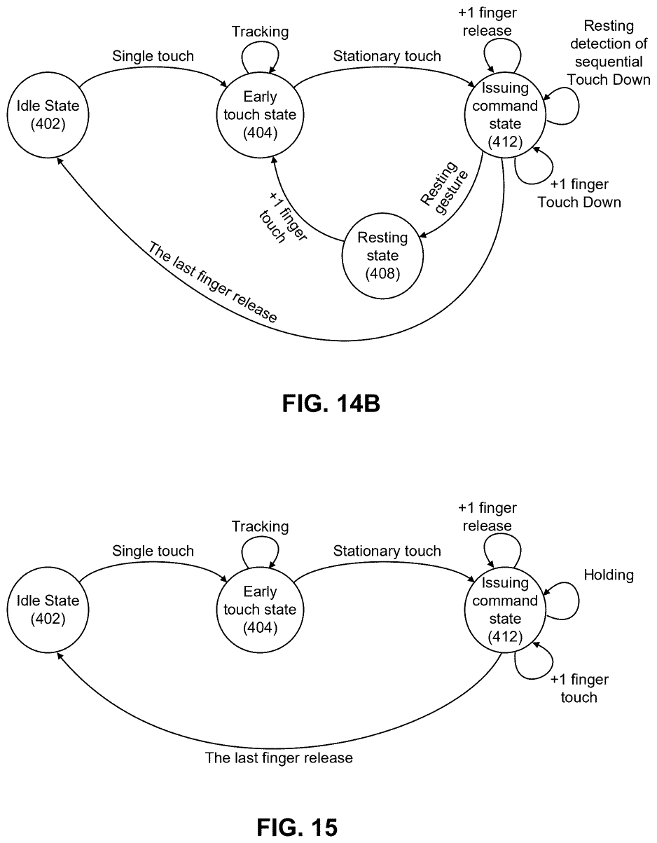

In another example, the virtual keyboard 200 performs resting detection with finger touch not at the same time, wherein the virtual keyboard 200 addresses the cases where multiple fingers contact the touch surface sequentially rather than simultaneously, which is common in multi-finger typing and other input scenarios. This example specifically handles the distinction between active touch events and resting states, reducing accidental input while preserving accurate typing. The flowchart of this example is shown in FIG. 14A, which is similar to the flowchart portion shown in FIG. 8A.

In this example, the virtual keyboard 200 begins by detecting finger touches, focusing on the down and up events of the fingers. This is important to identify whether the touch represents a typing action or a resting event, particularly when multiple fingers are placed on the touch surface one after another, as opposed to simultaneously.

In this example, each touch event is preprocessed to ensure the virtual keyboard 200 accurately tracking the sequence and timing of touch-down and touch-up events. This helps in differentiating between a keypress (which is a short-duration touch) and a rest (which is a longer-duration touch).

In this example, the virtual keyboard 200 continuously evaluates whether the conditions for resting are met. If a touch remains stationary and lasts longer than the specified threshold (for example, 500 ms), the virtual keyboard 200 enters the resting state. Otherwise, the touch is processed as a valid keypress.

In this example, the above-described valid keystroke filtering mechanism ensures that only intentional, active touches result in keypress events. Resting touches and unintentional light touches are filtered out to prevent accidental input.

In this example, a significant part is the handling of sequential touches. When multiple fingers make contact in sequence (that is one after another), the virtual keyboard 200 tracks each touch and determines if it should be processed as a valid touch or ignored as a resting event.

In this example, once the virtual keyboard 200 identifies the touch as resting, a TOUCH_REST event is sent to the state machine 232, which processes this event and refrains from issuing any keypress actions. This prevents the resting fingers from interfering with the typing process.

The state transition diagram of this example is shown in FIG. 14B, which involves the following states:
Idle state 402: The virtual keyboard 200 remains in this state when no active touches are detected. This is the default state before any touch interaction.
Early touch state 404: When a single finger or multiple fingers contact the touch surface, the virtual keyboard 200 enters the early touch state 404, wherein it tracks the touch and determines whether it should transition to the resting state 408 or issue a keypress (that is, the issuing command state 412).
Resting state 408: If the touch remains stationary for a period exceeding the resting threshold, the virtual keyboard 200 transitions to the resting state 408. At this point, the virtual keyboard 200 acknowledges the finger as resting and avoids issuing keypress events.
Issuing command state 412: When a valid keypress is detected (that is, a touch that is not resting), the virtual keyboard 200 transitions to the issuing command state 412, where the virtual keyboard 200 processes the input and triggers the corresponding keypress event.

In this example, the virtual keyboard 200 may be used in various scenarios. For example, in one scenario, when two fingers from the same hand contact the touch surface in rapid succession (such as within 30 ms of each other), they are identified as resting fingers rather than active typing inputs. This scenario prevents the virtual keyboard 200 from misinterpreting quick hand movements as typing gestures.

In another scenario, the virtual keyboard 200 handles the cases where multiple fingers contact the touch surface in sequence rather than at the same time. The virtual keyboard 200 tracks these touches and ensures that only intentional key presses result in input, while sequential resting touches are filtered out.

In another example, the virtual keyboard 200 performs long key handling focusing on managing long keypress, which is a common action where the user presses and holds a key for an extended time period to trigger specific functions (such as capital letters or special characters). FIG. 15 shows the state transition diagram of this example, which involves the following states:
Idle state 402: The virtual keyboard 200 begins in this state when there is no input detected.
Early touch state 404: When a single finger contacts the touch surface, the virtual keyboard 200 transitions to the early touch state 404 and tracks the touch.
Issuing command state 412: When the virtual keyboard 200 detects the finger holding down on the touch surface (based on a specified time threshold), the virtual keyboard 200 transitions to the issuing command state 412, where the virtual keyboard 200 processes the long keypress and issues the corresponding command.

In this example, a finger may contact the touch surface and remain in the same position without movement thereby giving rise to a stationary touch, which may be used as preparation for handling a potential long keypress. After a stationary touch is detected, the virtual keyboard 200 continues to monitor the holding action, and upon the release of the finger, the virtual keyboard 200 transitions to the issuing command state 412 and execute a command corresponding to the long keypress.

In other example, the virtual keyboard 200 manages scenarios where the user may rest one or more fingers or palms on the touch surface while continuing to type. The above-described resting detection method differentiates between intentional keypresses and resting fingers, ensuring that unintended touches are not processed as valid inputs.

In this example, when multiple figures contact the touch surface at the same time, the touches that last more than a predefined or preconfigured threshold period such as 250 ms are considered resting touches, while other finger touches are treated as valid typing inputs. The last keypress triggers the corresponding action with KEY_DOWN and KEY_UP functions.

In this example, when multiple figures contact the touch surface sequentially with typing after a predefined or preconfigured interval or period such an interval of 30 ms or longer, these sequential touches are treated as resting keys, except for the last key which is identified as an active touch. The virtual keyboard 200 processes the last key as a valid input with KEY_DOWN and KEY_UP functions.

In this example, the virtual keyboard 200 allows typing with the palm on the touch surface. The above-described palm detection prevents accidental typing by recognizing palms resting on the touch surface. Finger touches are considered as active typing inputs. In other words, Palm contact is rejected, while finger typing is processed normally with KEY_DOWN and KEY_UP functions.

In this example, the virtual keyboard 200 allows one hand resting on the touch surface, and the other hand typing. When one hand is resting on the touch surface, its finger touches are identified as resting touches. The active typing fingers of the other hand issue valid keycodes for KEY_DOWN and KEY_UP actions. Table 4 below shows a summary of these scenarios.

TABLE 4
REST + TYPING SCENARIOS

| No | Scenarios | Resting Detection and Behavior | Function |
|---|---|---|---|
| 1 | Multi-fingers touch at | Finger touches which hold ≥ | The last key has |
| | same time and long | 250 ms are considered as resting | KEY_DOWN, KEY_UP |
| | hold >= 250 ms and then | touches, the new active finger is | |
| | typing | considered a valid touch | |
| 2 | Multi-fingers touch | The sequential touch down are | The last key has |
| | sequentially and then | considered as resting touches | KEY_DOWN, KEY_UP |
| | typing in 30+ ms interval | and the last key is active touch | |
| | since the last key down | | |
| 3 | Typing with palm on | Palm will be rejected and be | The finger touch is |
| | touchscreen | considered as finger typing | considered as active |
| | | without palm | typing with |
| | | | KEY_DOWN, KEY_UP |
| 4 | One hand rests on touch | The first hand's finger touches | The second hand's finger |
| | screen, next hand typing | are considered as resting touches | touches issue the keycode |

In one example, the virtual keyboard 200 allows resting with finger touch at the same time, and then typing. More specifically, the virtual keyboard 200 in this example handles resting touches when multiple fingers are placed on the touch surface simultaneously, followed by typing actions. The virtual keyboard 200 differentiates between resting touches and intentional typing to avoid accidental inputs while maintaining a smooth typing experience.

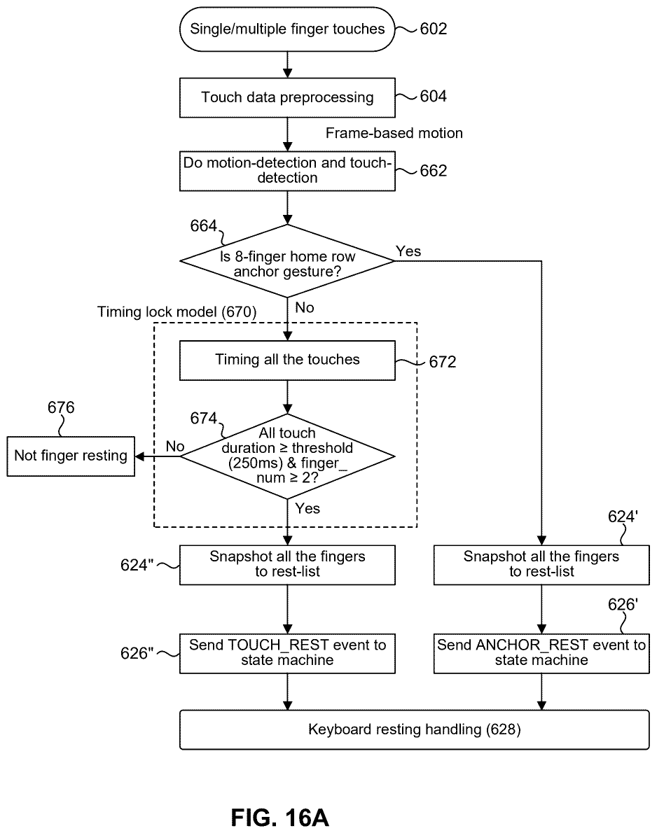

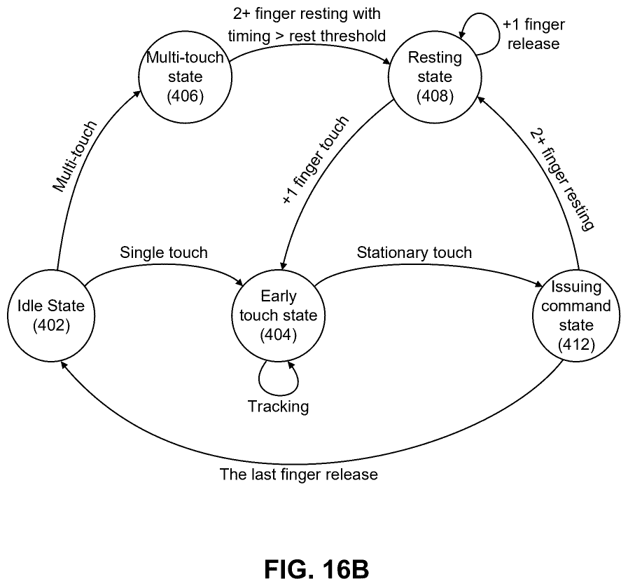

The flowchart of this example is shown in FIG. 16A, which is similar to the frame-based motion detection portion shown in FIG. 8B.

More specifically, at the touch data preprocessing step 604, the virtual keyboard 200 detects multiple finger touches and preprocesses the data to track each finger's position and pressure on the screen. The virtual keyboard 200 then uses the above-described frame-based motion detection to analyze the motion of the fingers to determine whether they are static (that is, resting) or in motion (that is, typing).

The virtual keyboard 200 may use a debounce timer to filter out unintended touches by determining whether the fingers have been held in place long enough to be considered as “resting” inputs.

The virtual keyboard 200 captures all fingers in the resting position and sends a “TOUCH_REST” event to the state machine 232 (step 626″), signaling that the user's fingers are at rest.

Moreover, the virtual keyboard 200 processes the rest state of the keyboard while waiting for valid typing inputs from any non-resting fingers.

The state transition diagram of this example is shown in FIG. 16B, which involves the following states:
Idle state 402: The system begins in an idle state, where no touches are detected.
Early touch state 404: When a single finger contacts the touch surface, the virtual keyboard 200 transitions to the early touch state 404 (which includes a single touch state).
Multi-touch state 406: If more fingers contact the touch surface, the virtual keyboard 200 transitions to this state to track their positions and motions, and analyze whether they are resting or typing.
Resting state 408: After detecting that the fingers are resting on the touch surface (for example, static touch with enough pressure or time), the virtual keyboard 200 enters the resting state 408.
Issuing command state 412: If a typing action is detected, the virtual keyboard 200 transitions to the issuing command state 412, where the virtual keyboard 200 processes key inputs as valid typing actions.

In another example, the virtual keyboard 200 handles the scenarios where fingers contact the touch surface at different times (rather than simultaneously), and then the user transitions from resting to typing. The virtual keyboard 200 in this example focuses on recognizing these staggered inputs and filtering out unintended keypresses while identifying valid typing actions.

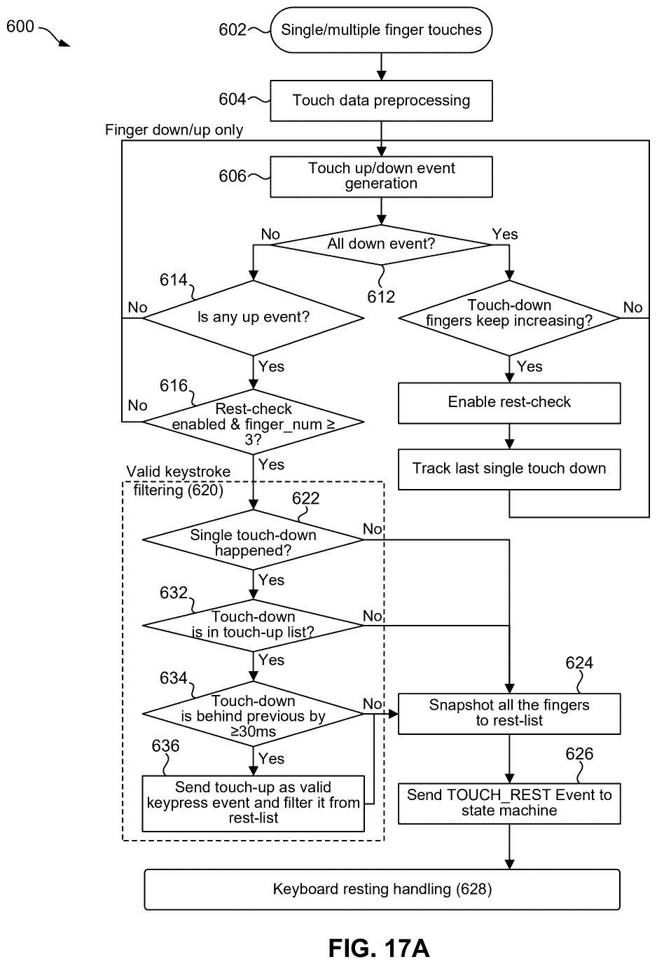

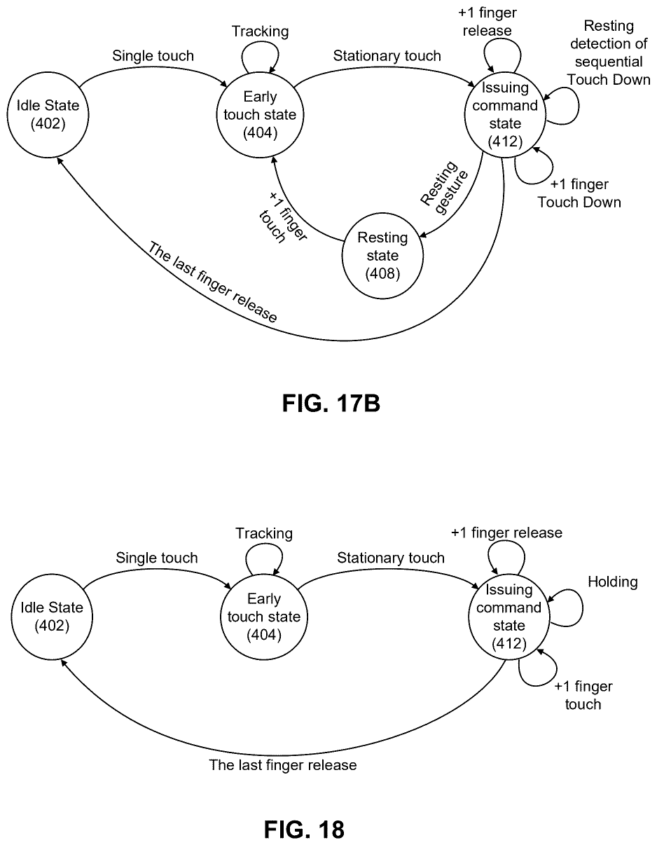

The flowchart of this example is shown in FIG. 17A, which is similar to the flowchart portion shown in FIG. 8A. More specifically, the virtual keyboard 200 in this example begins with detecting Touch_Down or Touch_Up events, which correspond to the user placing fingers on or lifting them from the touch surface.

In touch data preprocessing (step 604), the virtual keyboard 200 in this example analyzes the timing and sequence of touches, determining whether multiple fingers have been placed sequentially or simultaneously on the touch surface.

The virtual keyboard 200 in this example may use a debounce timer. More specifically, a debounce timer is employed to verify if the touches meet the resting threshold, and if so, the virtual keyboard 200 determines which touches are resting.

The virtual keyboard 200 in this example uses valid keystroke filtering 620, which involves filtering out invalid keystrokes. The virtual keyboard 200 checks whether a keypress was intentional by comparing touch durations and pressure against predefined thresholds.

Once the virtual keyboard 200 recognizes the resting state 408, it takes a snapshot of the resting fingers to avoid accidental keypresses during typing. Then, the virtual keyboard 200 sends a “TOUCH_REST” event to the state machine 232, signaling that the fingers are resting.

In this example, the virtual keyboard 200 handles the resting state 408 at step 628 until an active typing event is detected.

FIG. 17B is the state transition diagram of this example, which involves the following states:
Idle state 402: The virtual keyboard 200 starts in the idle state 402, waiting for any touch input.
Early touch state 404: When a single finger contacts the touch surface, the virtual keyboard 200 transitions to the early touch state 404 (which includes a single touch state).
Multi-touch state 406: If more fingers contact the touch surface, the virtual keyboard 200 transitions to this state to track their positions and motions, and analyze whether they are resting or typing.
Resting state 408: After detecting that the fingers are resting on the touch surface (for example, static touch with enough pressure or time), the virtual keyboard 200 enters the resting state 408, capturing the rest state of each finger.
Issuing command state 412: Once a valid typing action is detected (after filtering out accidental touches), the virtual keyboard 200 transitions to the issuing command state 412, where the virtual keyboard 200 processes valid keypresses.

Thus, the virtual keyboard 200 tracks the touches and transitions smoothly between states based on the user's actions.

In another example, the virtual keyboard 200 handles typing with palm on the touch surface. In other words, the virtual keyboard 200 in this example addresses the scenarios where the user's palms rest on the touch surface while typing, which is a common occurrence when using a virtual keyboard on large touchscreens such as on tablets or foldable PCs.

FIG. 18 shows the state transition diagram of this example, which involves the following states:
Idle state 402: The virtual keyboard 200 starts in the idle state 402, waiting for any touch input.
Early touch state 404: When the virtual keyboard 200 detects an initial touch (for example, from a finger), it transitions to the early touch state 404 (which includes a single touch state). If additional touches are detected (for example, additional fingers), the virtual keyboard 200 tracks these touches to determine whether they are active typing inputs.
Resting state 408: After detecting that the fingers are resting on the touch surface (for example, static touch with enough pressure or time), the virtual keyboard 200 enters the resting state 408, capturing the rest state of each finger.
Issuing command state 412: Once a valid typing action is detected (based on finger touch, movement, or pressure), the virtual keyboard 200 transitions to the issuing command state 412 to processes valid keypresses.

In this example, if the virtual keyboard 200 detects that the fingers remain on the touch surface without significant movement or pressure changes, it further monitors the touch behavior.

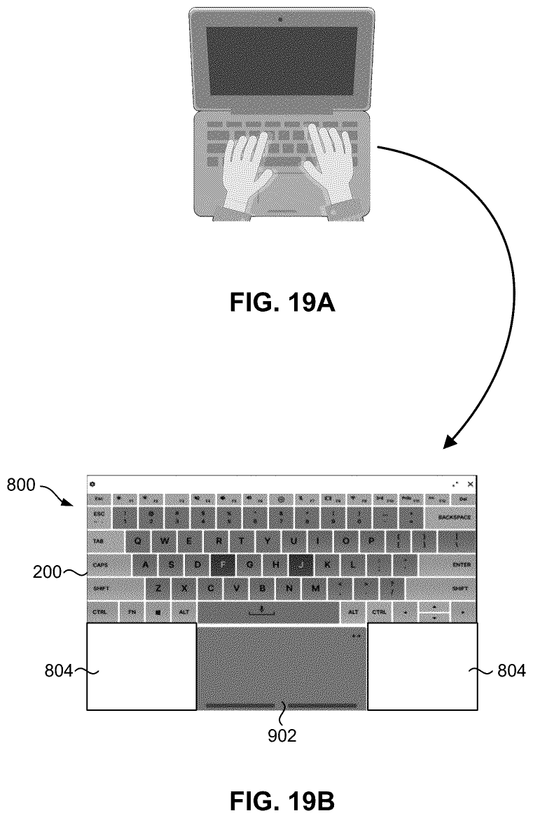

In this example, the virtual keyboard 200 uses palm rejection techniques to ignore any touches that come from the palm area. As shown in FIGS. 19A and 19B, the palm area 804 (in which palm touches are likely to occur) may be defined as the entire area on the near side of the virtual keyboard 200, or, if a touchpad area 902 is defined for controlling the cursor, the area on the near side of the virtual keyboard 200 excluding the touchpad area 902.

In this example, the low-level touch-panel driver automatically filters out palm touches in the palm area 802, ensuring that they are not misinterpreted as typing inputs. The state machine 232 focuses only on handling the inputs from fingers, which are considered active typing actions.

Since the palm touches are rejected by the low-level touch-panel driver, only the valid finger touches are handled by the state machine 232, and thus the state transition does not involve any resting state (see FIG. 18). This ensures smooth typing interactions without accidental keypresses caused by resting palms.

In another example, the virtual keyboard 200 differentiates finger resting and touch operations based on the change pattern of the number of finger touches. For example, if the number of touches increases (which may increase fast or slow), the virtual keyboard 200 determines that the increased number of touches are finger resting on the touch surface. Otherwise, for example, if the number of touches increases and then decrease, or if the number of touches decreases and then increases, the virtual keyboard 200 determines that the changing number of touches are touch operations such as typing or gesture performing.

Embodiment of this example is particularly useful in scenarios where users may rest palms while typing, providing a more ergonomic and error-free typing experience on touchscreen devices.

Although in above embodiments, eight (8) finger touches are used for anchoring, in some embodiments, other number of multiple finger touches such as two, three, four, five, six, seven, nine, or ten finger touches may alternatively or additionally used for anchoring.

Although in above embodiments and examples various the features such as multi-finger touch detection, accidental touch avoidance, palm resting, anchoring, and/or the like are described for the virtual keyboards 200, those skilled in the art will appreciate that at least some of these features may be used for other suitable touch-based technologies.

For example, in some embodiments, instead of being used in virtual keyboards, the features disclosed herein may be used in gesture-based applications. As an example, the features disclosed herein such as the resting-state detection method disclosed herein may be used on gesture-based inputs, where touch panels may detect touch points and gestures such as swipes, pinches, taps, and/or the like, to distinguish between typing, resting, and accidental touches. In these embodiments, the system may rely on artificial intelligence (AI) based gesture recognition rather than touch location and timing.

In some embodiments, the features disclosed herein may be used with other pressure-sensitive touch panels, which dynamically measure the pressure applied during typing and resting.

In some embodiments, the features disclosed herein may be used with AI-driven predictive typing models, which may learn a user's typing behavior over time, predicting what input the user is likely intending based on previous patterns. Such a model may address similar issues of touch accuracy and accidental inputs by predicting the user's next input.

In some embodiments, the features disclosed herein may be used in systems with hover detection (detecting hovering fingers, styli, pointers, and/or the like) and contactless inputs. By detecting proximity rather than touch, such systems may eliminate accidental touch inputs entirely by recognizing intentional touches as those that break the hover boundary and make contact.

The virtual keyboard 200 disclosed herein and/or the features thereof may be used in many applications across a range of devices, industries, and technical applications because of the versatile and impactful nature of the virtual keyboard 200. Examples of applicable applications include:
Automotive Industry (such as in-vehicle touch interfaces):

The virtual keyboard 200 disclosed herein and/or the features thereof may be applied to touch-based controls in vehicles. As automotive interfaces shift towards touchscreen and virtual control panels, integrating multi-touch solutions that prevent accidental touch or rest-based misinput may enhance safety and usability. The virtual keyboard 200 disclosed herein and/or the features thereof may be employed in areas such as dashboard controls, infotainment systems, haptic feedback steering wheels, and/or the like.
Wearable technologies (such as smartwatches, augmented reality (AR) devices, and/or the like):

The virtual keyboard 200 disclosed herein and/or the features thereof, such as multi-finger touch detection and resting-state processing, may be extended to the interface solutions for smaller devices such as smartwatches, AR glasses, and/or the like. These devices often face challenges with limited touch surface areas, which may result in accidental inputs or misrecognition of commands. Applying the resting-state detection and anchor touch technology described herein may significantly improve interaction accuracy in wearable technologies.
Smart home appliances:

With the proliferation of smart home devices featuring touch-based control panels (for example, thermostats, refrigerators, lighting systems, and/or the like), adapting the virtual keyboard 200 disclosed herein and/or the features thereof, such as the multi-touch handling mechanism, may prevent erroneous inputs, especially in environments where users may interact with these smart home device using multiple fingers or from unconventional positions, and may create more reliable touch-based interfaces for home automation systems.
Healthcare and medical devices:

The virtual keyboard 200 disclosed herein and/or the features thereof may be extended to touch-based medical interfaces such as those used in diagnostic equipment or patient monitoring systems. For example, multi-touch and palm resting detection methods disclosed herein may prevent accidental touches in critical environments, ensuring precision and accuracy during medical procedures or when operating medical equipment.
Foldable PC integration:

The virtual keyboard 200 disclosed herein and/or the features thereof may be used with computing devices having foldable and flexible screens such as foldable PCs, foldable laptops, tablets, and/or the like.
Adaptive office solutions:

The virtual keyboard 200 disclosed herein and/or the features thereof may be used in adaptive office solutions to enhance user comfort during long typing sessions on virtual keyboards, combining the accuracy of physical typing with the adaptability of touchscreens.
Consumer Electronics:

As consumer electronics continue to evolve towards slimmer, more portable, and screen-dominated designs, the virtual keyboard 200 disclosed herein and/or the features thereof, such as virtual keyboards with palm resting and multi-finger input capabilities, may replace traditional physical keyboards. The virtual keyboard 200 disclosed herein and/or the features thereof may be applied to ultra-thin laptops, hybrid devices, gaming systems, and/or the like, where users need fast, reliable, and comfortable typing interfaces.

The virtual keyboard 200 disclosed herein and/or the features thereof provide several novel solutions to at least some of the technical problems identified herein, focusing on improving multi-finger detection, reducing accidental touches, and enhancing user experience through advanced gesture and resting detection mechanisms.

For example, the herein-disclosed multi-gesture detection with intelligent state transitions allows detecting and processing a wide range of user gestures such as swiping, pinching, tapping, long presses, and/or the like, while seamlessly switching between gesture recognition and typing modes. A state machine manages the transitions between different touch states (such as typing, resting, gesture mode, and/or the like), ensuring that typing actions do not conflict with gesture-based inputs. This prevents situations where unintentional gestures (such as moving a finger between keys) trigger unintended actions.

With the herein-disclosed resting finger detection and adaptive keyboard movement, a touch-enabled computing device may incorporate a carefully designed resting detection method that distinguishes between fingers resting on the touch surface and active typing input. When fingers are detected in the resting state (for example, based on touch duration and pressure), the touch-enabled computing device may dynamically adjust the keyboard layout or temporarily lock the keyboard to prevent accidental inputs. This reduces fatigue by allowing users to rest their fingers on the virtual keyboard or more generally on the touch surface. Additionally, the touch-enabled computing device may adapt to the user's typing posture, repositioning keys to better fit the user's natural hand position.

With the herein-disclosed accidental touch removal and coactivation filtering, accidental touches, especially when multiple fingers are resting on the touch surface, are filtered using an advanced coactivation detection method. By evaluating the pressure, timing, and position of each touchpoint, the touch-enabled computing device may determine whether the touch is intentional or accidental. For example, if multiple fingers are detected resting on the home-row keys (such as the keys “F”, “J”, and/or the like), the touch-enabled computing device may classify this as a resting state and prevent key activation, even if those fingers move slightly. This reduces errors that occur from light brushes or accidental contacts.

With the herein-disclosed key activation mechanism based on state and pressure models, the touch-enabled computing device may use a state machine to determine when a touch should activate a keypress. This involves detecting whether a finger is in an “active touch” state, which is based on the timing of the touch (for example, how long the finger remains on the touch surface), the pressure applied, the movement pattern, and/or the like. Key activation occurs when these parameters indicate intentional input, preventing accidental presses from fingers that are resting or moving across the touch surface. Additionally, the pressure model allows the touch-enabled computing device to distinguish between light touches (that is, resting) and firm touches (that is, intentional typing), thereby further improving typing accuracy.

With the herein-disclosed anchoring detection for typing adjustment and gesture recognition, the touch-enabled computing device may include an anchoring detection feature that identifies when users rest their fingers on the home-row keys (such as the keys “F”, “J”, and/or the like). This information is used to adapt the keyboard layout to match the user's typing posture, making it easier for the user to type efficiently without needing to lift their hands unnecessarily. The anchoring mechanism also facilitates gesture recognition, allowing users to switch between typing and scrolling or swiping without triggering unintentional keyboard inputs.

With the herein-disclosed virtual pressure and hand geometry information, touch precision is further improved. The touch-enabled computing device may use virtual pressure and hand geometry data to filter out unintended touches. By analyzing the shape and size of the user's hand, as well as the pressure exerted by each finger, the touch-enabled computing device may better understand whether a touch is intended to be a keypress or a resting touch. This ensures that only deliberate inputs are registered as keystrokes, while lighter accidental touches are ignored.

The methods disclosed herein utilize a global state machine with resting and anchoring states to closely emulate the typing behavior of a physical keyboard on touch-enabled devices. By processing all the finger touches into distinct keyboard states, the methods disclosed herein adapt to user behavior models typically associated with physical keyboard usage. In some embodiments, the “resting state” is used, which may filter out over 82% of accidental touches, significantly improving typing accuracy. This is important in touch-based environments where unintended touches often occur.

In some embodiments, the “anchoring state” is introduced to help align fingers in a way that simulates the experience of using a physical keyboard. In this state, users can adjust the position of the keyboard to support palm resting while typing, enhancing ergonomics and comfort during extended typing sessions. This feature, in particular, mimics the tactile feedback and user interaction found in physical keyboards.

In some embodiments, the methods disclosed herein also incorporate the issuing command state, where only Touch_Up events (that is, lifting the finger) trigger keycode functions, ensuring that resting fingers are detected and filtered out before any keypress is registered. This provides a smoother and more precise typing experience by avoiding accidental key activations.

In some embodiments, to address the two most common types of accidental touches in multi-finger typing (that is, coactivation and light touch), the methods disclosed herein use virtual pressure detection and timing checks. These features help distinguish between intentional and unintentional inputs, further refining the typing process. Coactivation touches, where multiple fingers inadvertently press on the touch surface at once, are filtered using virtual pressure detection, while light touches are managed with pressure thresholds and timing locks.

In some embodiments, the methods disclosed herein use the resting detection method that operates at the touchpoint level, meaning that it can detect resting fingers whether they contact the touch surface simultaneously or at different times. Additionally, the resting detection method does not limit the number of fingers involved in the resting detection process, offering flexibility and scalability across different user interactions.

In various embodiments, the computing device and methods disclosed herein provide various technical benefits.

For example, the computing device and methods disclosed herein provide reduction of typing fatigue. By enabling both multi-finger resting and palm resting modes, the computing device and methods disclosed herein significantly reduce typing fatigue. This improvement allows users to rest their hands while typing, replicating the comfort and ergonomics of physical keyboards.

The computing device and methods disclosed herein provide enhanced user experience. The virtual keyboard's performance may reach, for example, approximately 80% of a physical keyboard's speed and accuracy, providing a highly competitive and effective alternative for users accustomed to traditional keyboards.

The computing device and methods disclosed herein provide multi-finger and blind typing support. The computing device and methods disclosed herein provide enable users to type efficiently with multiple fingers and even supports blind typing, a feature that many prior-art technologies have struggled to implement effectively. This is especially beneficial for users with a background in touch typing, enhancing productivity.

The computing device and methods disclosed herein provide replacement of physical keyboards in foldable PCs. The computing device and methods disclosed herein provide an opportunity for virtual keyboards to replace physical ones in foldable PC designs, helping to streamline and optimize the design and functionality of these devices.

The computing device and methods disclosed herein provide practical integration with capacitive sensors. The virtual keyboard leverages existing capacitive sensor data without requiring additional hardware or sensors, making it a cost-effective and practical solution for manufacturers and designers of touchscreen devices.

The computing device and methods disclosed herein provide accidental touch filtering. One of the benefits is the reduction of accidental touches during multi-finger typing. The carefully designed filtering mechanisms of the computing device and methods disclosed herein ensure that accidental touches are minimized to, for example, less than 10%, demonstrating a significant improvement over prior-art virtual keyboard technologies.

### C. Definition of Some Terms

Herein, the term “predefined” (for example, a “predefined” item such as a “predefined” parameter) refers to an item defined before the method disclosed herein is performed (for example, defined as a system design parameter such as defined by relevant standards).

Herein, the term “preconfigured” (for example, a “preconfigured” item such as a “preconfigured” parameter) refers to an item configured by a suitable apparatus before a certain even occurs.

Herein, use of language such as “at least one of X, Y, and Z,” “at least one of X, Y, or Z,” “at least one or more of X, Y, and Z,” “at least one or more of X, Y, and/or Z,” or “at least one of X, Y, and/or Z,” is intended to be inclusive of both a single item (e.g., just X, or just Y, or just Z) and multiple items (e.g., {X and Y}, {X and Z}, {Y and Z}, or {X, Y, and Z}). The phrase “at least one of” and similar phrases are not intended to convey a requirement that each possible item must be present, although each possible item may be present.

In some embodiments, the methods disclosed herein may be implemented as computer-executable instructions stored in one or more non-transitory computer-readable storage devices (in the form of software, firmware, or a combination thereof) such that, the instructions, when executed, may cause one or more physical components such as one or more circuits to perform the methods disclosed herein.

For example, in some embodiments, an apparatus comprising one or more processors functionally connected to one or more non-transitory computer-readable storage devices or media may be used to perform the methods disclosed herein, wherein the one or more non-transitory computer-readable storage devices or media store the computer-executable instructions of the methods disclosed herein, and the one or more processors may read the computer-executable instructions from the one or more non-transitory computer-readable storage devices or media, and executes the instructions to perform the methods disclosed herein.

In some embodiments, an apparatus may not have any processors or computer-readable storage devices or media. Rather, the apparatus may comprise any other suitable physical or virtual (explained below) components for implementing the methods disclosed herein.

In some embodiments, the computer-executable instructions that implement the methods disclosed herein may be one or more computer programs, one or more program products, or a combination thereof.

In some embodiments, the methods disclosed herein may be implemented as one or more circuits, one or more components, one or more units, one or more modules, one or more integrated-circuit (IC) chips, one or more chipsets, one or more devices, one or more apparatuses, one or more systems, and/or the like.

The one or more circuits, one or more components, one or more units, one or more modules, one or more IC chips, one or more chipsets, one or more devices, one or more apparatuses, or one or more systems may be physical, virtual, or a combination thereof. Herein, the term “virtual” (such as a “virtual apparatus”) refers to a circuit, component, unit, module, chipset, device, apparatus, system, or the like that is simulated or emulated or otherwise formed using suitable software or firmware such that it appears as if it is “real” or physical).

The present disclosure encompasses various embodiments, including not only method embodiments, but also other embodiments such as apparatus embodiments and embodiments related to non-transitory computer readable storage media. Embodiments may incorporate, individually or in combinations, the features disclosed herein.

Although this disclosure refers to illustrative embodiments, this is not intended to be construed in a limiting sense. Various modifications and combinations of the illustrative embodiments, as well as other embodiments of the disclosure, will be apparent to persons skilled in the art upon reference to the description.

Features disclosed herein in the context of any particular embodiments may also or instead be implemented in other embodiments. Method embodiments, for example, may also or instead be implemented in apparatus, system, and/or computer program product embodiments. In addition, although embodiments are described primarily in the context of methods and apparatus, other implementations are also contemplated, as instructions stored on one or more non-transitory computer-readable media, for example. Such media could store programming or instructions to perform any of various methods consistent with the present disclosure.

Those skilled in the art will appreciate that the various embodiments and/or features disclosed herein may be customized and/or combined as needed or desired. Moreover, although embodiments have been described above with reference to the accompanying drawings, those of skill in the art will appreciate that variations and modifications may be made without departing from the scope thereof as defined by the appended claims.

1. A computerized method comprising:
obtaining a plurality of first touches on a touch surface; and
determining that the plurality of first touches, as a group, are in a first state of resting on the touch surface;
obtaining one or more second touches on a touch surface;
determining that the one or more second touches are in a second state of issuing one or more commands; and
among the first and second touches, only using the one or more second touches for command generation.

2. (canceled)

3. (canceled)

4. (canceled)

5. The method of claim 23 further comprising:
determining a plurality of fourth touches on a predefined row of the virtual keyboard;
determining a movement of the plurality of fourth touches; and
moving the virtual keyboard with the movement of the plurality of fourth touches if the movement of the plurality of fourth touches is substantially along a predefined direction with respect to the touch surface.

6. An apparatus comprising:
one or more processors; and
one or more non-transitory computer-readable storage media comprising computer-executable instructions;
wherein the instructions, when executed, cause one or more processors to perform actions comprising:
obtaining a plurality of first touches on a touch surface;
determining that the plurality of first touches, as a group, are in a first state of resting on the touch surface;
obtaining one or more second touches on a touch surface;
determining that the one or more second touches are in a second state of issuing one or more commands; and
among the first and second touches, only using the one or more second touches for command generation.

7. (canceled)

8. (canceled)

9. (canceled)

10. The apparatus of claim 6, wherein the actions further comprise:
obtaining at least six third touches on the touch surface;
initializing a virtual keyboard on the touch surface such that a plurality of keys of the virtual keyboard are positioned in accordance with positions of the plurality of third touches.

11. One or more non-transitory computer-readable storage media comprising computer-executable instructions, wherein the instructions, when executed, cause one or more circuits to perform actions comprising:
obtaining a plurality of first touches on a touch surface;
determining that the plurality of first touches, as a group, are in a first state of resting on the touch surface;
obtaining one or more second touches on a touch surface;
determining that the one or more second touches are in a second state of issuing one or more commands; and
among the first and second touches, only using the one or more second touches for command generation.

12. The one or more non-transitory computer-readable storage media of claim 28, wherein said the plurality of first touches being more than one touches sequentially contacting the touch surface comprises:
the plurality of first touches being more than one touches belonging to a same hand and sequentially contacting the touch surface.

13. The one or more non-transitory computer-readable storage media of claim 28, wherein said the plurality of first touches being more than one touches contacting the touch surface substantially at the same time and remaining in contact with the touch surface for longer than the second time duration comprises:
the plurality of first touches being more than one touches contacting the touch surface within a time period and remaining in contact with the touch surface for longer than the second time duration.

14. The one or more non-transitory computer-readable storage media of claim 11, wherein the actions further comprise:
obtaining one or more third touches on the touch surface;
obtaining a touch-force estimate for each of the one or more third touches; and
determining that the one or more third touches are accidental touches if any of following second conditions is true:
the one or more third touches being a plurality of third touches contacting the touch surface substantially at a same time and the touch-force of each of the one or more third touches being less than a first force threshold,
the one or more third touches being a single third touch and the touch-force thereof being less than a second force threshold, or
a combination thereof.

15. The one or more non-transitory computer-readable storage media of claim 14, wherein said the one or more third touches being the plurality of third touches contacting the touch surface substantially at the same time and the touch-force of each of the one or more third touches being less than the first force threshold comprises:
the one or more third touches being the plurality of third touches belonging to a same hand and contacting the touch surface substantially at the same time,
the touch-force of each of the one or more third touches being less than the first force threshold, and
the one or more third touches being maintained on the touch surface for less than a third time duration.

16. The one or more non-transitory computer-readable storage media of claim 14, wherein said the one or more third touches being the single third touch and the touch-force thereof being less than the second force threshold comprises:
the one or more third touches being the single third touch and the touch-force thereof being less than the second force threshold and being maintained on the touch surface for less than a fourth time duration.

17. The one or more non-transitory computer-readable storage media of claim 11, wherein the actions further comprise:
obtaining at least six third touches on the touch surface; and
initializing a virtual keyboard on the touch surface.

18. The one or more non-transitory computer-readable storage media of claim 17, wherein said initializing the virtual keyboard on the touch surface comprises:
initializing and positioning the virtual keyboard on the touch surface such that a plurality of keys of the virtual keyboard are positioned in accordance with positions of the plurality of third touches.

19. The one or more non-transitory computer-readable storage media of claim 17, wherein the actions further comprise:
determining a plurality of fourth touches on a predefined row of the virtual keyboard;
determining a movement of the plurality of fourth touches; and
moving the virtual keyboard with the movement of the plurality of fourth touches if the movement of the plurality of fourth touches is substantially along a predefined direction with respect to the touch surface.

20. The one or more non-transitory computer-readable storage media of claim 11, wherein the actions further comprise:
obtaining a plurality of fourth touches substantially contacting a same position on the touch surface within a fifth time duration; and
generating one touch event for the plurality of fourth touches.

21. The method of claim 1 further comprising:
using a state machine for said determining that the plurality of first touches are in the first state of resting on the touch surface and said determining that the one or more second touches are in the second state of issuing one or more commands; and
wherein the state machine comprises the first and second states, and further comprises:
a third state representing a plurality of touches contacting the touch surface, and
a fourth state representing a single active touch contacting the touch surface.

22. The method of claim 1, wherein said determining that the plurality of first touches are in the first state of resting on the touch surface comprises:
determining that the plurality of first touches are in the first state of resting on the touch surface if any of following first conditions is true:
the plurality of first touches being more than one touches sequentially contacting the touch surface,
the plurality of first touches being more than one touches contacting the touch surface substantially at a same time and remaining in contact with the touch surface for longer than a second time duration,
the plurality of first touches comprising one or more palm touches in contact with the touch surface at one or more locations outside an input area or at one or more locations inside a resting area on a near side of the input area, the input area and resting area being defined prior to the one or more first touches in contact with the touch surface, or
a combination thereof.

23. The method of claim 1 further comprising:
obtaining at least six third touches on the touch surface; and
initializing a virtual keyboard on the touch surface such that a plurality of keys of the virtual keyboard are positioned in accordance with positions of the plurality of third touches.

24. The apparatus of claim 6, wherein the actions further comprise:
using a state machine for said determining that the plurality of first touches are in the first state of resting on the touch surface and said determining that the one or more second touches are in the second state of issuing one or more commands;
wherein the state machine comprises the first and second states, and further comprises:
a third state representing a plurality of touches contacting the touch surface, and
a fourth state representing a single active touch contacting the touch surface.

25. The apparatus of claim 6, wherein said determining that the plurality of first touches are in the first state of resting on the touch surface comprises:
determining that the plurality of first touches are in the first state of resting on the touch surface if any of following first conditions is true:
the plurality of first touches being more than one touches sequentially contacting the touch surface,
the plurality of first touches being more than one touches contacting the touch surface substantially at a same time and remaining in contact with the touch surface for longer than a second time duration,
the plurality of first touches comprising one or more palm touches in contact with the touch surface at one or more locations outside an input area or at one or more locations inside a resting area on a near side of the input area, the input area and resting area being defined prior to the one or more first touches in contact with the touch surface, or
a combination thereof.

26. The apparatus of claim 10, wherein the actions further comprise:
determining a plurality of fourth touches on a predefined row of the virtual keyboard;
determining a movement of the plurality of fourth touches; and
moving the virtual keyboard with the movement of the plurality of fourth touches if the movement of the plurality of fourth touches is substantially along a predefined direction with respect to the touch surface.

27. The one or more non-transitory computer-readable storage media of claim 11, wherein the method further comprises:
using a state machine for said determining that the plurality of first touches are in the first state of resting on the touch surface and said determining that the one or more second touches are in the second state of issuing one or more commands;
wherein the state machine comprises the first and second states;
wherein the first state represents one or more touches resting on the touch surface, and the second state represents one or more touches issuing one or more commands; and
wherein the state machine further comprises:
a third state representing a plurality of touches contacting the touch surface, and
a fourth state representing a single active touch contacting the touch surface.

28. The one or more non-transitory computer-readable storage media of claim 11, wherein said determining that the plurality of first touches are in the first state of resting on the touch surface comprises:
determining that the plurality of first touches are in the first state of resting on the touch surface if any of following first conditions is true:
the plurality of first touches being more than one touches sequentially contacting the touch surface,
the plurality of first touches being more than one touches contacting the touch surface substantially at a same time and remaining in contact with the touch surface for longer than a second time duration,
the plurality of first touches comprising one or more palm touches in contact with the touch surface at one or more locations outside an input area or at one or more locations inside a resting area on a near side of the input area, the input area and resting area being defined prior to the one or more first touches in contact with the touch surface, or
a combination thereof.

29. The one or more non-transitory computer-readable storage media of claim 19, wherein the virtual keyboard is the input area, and an area of the touch surface on a near side of the virtual keyboard is the resting area; and
wherein the actions further comprise:
adjusting a size of resting area while moving the virtual keyboard.

30. The one or more non-transitory computer-readable storage media of claim 19, wherein the predefined row of the virtual keyboard is a row of the virtual keyboard comprising a “F” key and a “J” key.
